(19) United States
(12) Patent Application Publication
(10) Pub. No.: US 2026/0239382 A1
(43) Pub. Date: Aug. 13, 2026

(54) META INFORMATION SIGNALING FOR NETWORK DEVICES

(71) Applicant: QUALCOMM Incorporated, San Diego, CA (US)

(72) Inventors: Rajeev KUMAR, San Diego, CA (US); Aziz GHOLMIEH, Del Mar, CA (US); Juan ZHANG, Beijing (CN); Miguel GRIOT, La Jolla, CA (US); Shankar KRISHNAN, San Diego, CA (US); Charles Nung LO, San Diego, CA (US)

(21) Appl. No.: 19/153,880

(22) PCT Filed: Apr. 5, 2023
(86) PCT No.: PCT/CN2023/086356

§ 371 Date: Aug. 5, 2025

(51) Int. Cl. H04W 72/25; H04W 72/0453; H04W 72/51

(52) U.S. Cl. CPC H04W 72/25; H04W 72/0453; H04W 72/51

(57) ABSTRACT

Methods, systems, and devices for wireless communications are described. A radio access network (RAN) node may receive a message including meta information for a machine learning model that is operated by one or more devices within the coverage area of the RAN node (e.g., supported by the RAN node), where the machine learning model may be transparent to the RAN node. The meta information may include applicability information for control and management of the machine learning model by the RAN node. In some examples, the RAN node may receive the meta information from various logical functions. In some other examples, the RAN node may receive the meta information from the one or more devices. In response to receiving the meta information, the RAN node may transmit a model management message instructing a device of the one or more devices to perform a model management operation for the machine learning model.

### CROSS REFERENCE

The present Application for Patent is a 371 national phase filing of International Patent Application No. PCT/CN2023/086356 by KUMAR et al., entitled “META INFORMATION SIGNALING FOR NETWORK DEVICES,” filed Apr. 5, 2023, assigned to the assignee hereof, and expressly incorporated by reference herein.

### FIELD OF TECHNOLOGY

The following relates to wireless communications, including meta information signaling for network devices.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support meta information signaling for network devices. For example, the described techniques provide for a radio access network (RAN) node to receive meta information associated with a machine learning (ML) model operated by a user equipment (UE), where the ML model may be delivered to the UE transparent to the RAN node. Such techniques may enable the RAN node to manage the ML model at the UE without having an indication of (or knowledge of) the ML model, or some (or all) parameters of the ML model, used by or stored at the UE. For example, the RAN node may receive a message including meta information for a ML model that is operated by one or more devices (e.g., UEs) within the coverage area of the RAN node (e.g., supported by the RAN node), where the ML model may be transparent to the RAN node. The meta information may include applicability information for control and management of the ML model by the RAN node. In some examples, the RAN node may receive the meta information from one or more logical functions. In some other examples, the RAN node may receive the meta information from the one or more devices. In response to receiving the meta information, the RAN node may transmit a model management message instructing a device of the one or more devices to perform a model management operation for the ML model.

A method for wireless communications at a RAN node is described. The method may include receiving a message including meta information for a ML model at one or more devices, where the RAN node supports communications for the one or more devices, the meta information including applicability information for control and management of the ML model at the RAN node and transmitting, based on the meta information, a model management message instructing a device of the one or more devices to perform a model management operation for the ML model.

An apparatus for wireless communications at a RAN node is described. The apparatus may include a processor, memory coupled with the processor, and instructions stored in the memory. The instructions may be executable by the processor to cause the apparatus to receive a message including meta information for a ML model at one or more devices, where the RAN node supports communications for the one or more devices, the meta information including applicability information for control and management of the ML model at the RAN node and transmit, based on the meta information, a model management message instructing a device of the one or more devices to perform a model management operation for the ML model.

Another apparatus for wireless communications at a RAN node is described. The apparatus may include means for receiving a message including meta information for a ML model at one or more devices, where the RAN node supports communications for the one or more devices, the meta information including applicability information for control and management of the ML model at the RAN node and means for transmitting, based on the meta information, a model management message instructing a device of the one or more devices to perform a model management operation for the ML model.

A non-transitory computer-readable medium storing code for wireless communications at a RAN node is described. The code may include instructions executable by a processor to receive a message including meta information for a ML model at one or more devices, where the RAN node supports communications for the one or more devices, the meta information including applicability information for control and management of the ML model at the RAN node and transmit, based on the meta information, a model management message instructing a device of the one or more devices to perform a model management operation for the ML model.

Some examples of the method, apparatuses, and non-transitory computer-readable medium described herein may further include operations, features, means, or instructions for transmitting, to the one or more devices, a control message requesting the meta information associated with the ML model, the control message including an identifier of the ML model, where the message including the meta information may be received from the one or more devices in response to the control message.

Some examples of the method, apparatuses, and non-transitory computer-readable medium described herein may further include operations, features, means, or instructions for receiving, from the one or more devices, a capability message indicating that the one or more devices support the ML model, the capability message including the applicability information, where transmission of the control message may be in response to the capability message.

Some examples of the method, apparatuses, and non-transitory computer-readable medium described herein may further include operations, features, means, or instructions for receiving, from the one or more devices, an indication that the one or more devices may have an update for the meta information, where transmission of the control message may be in response to the indication.

In some examples of the method, apparatuses, and non-transitory computer-readable medium described herein, the message includes a meta information update request message and may be received from a logical function in communication with the RAN node and the method, apparatuses, and non-transitory computer-readable medium may include further operations, features, means, or instructions for transmitting, to the logical function, a meta information update response message indicating that the meta information associated with the ML model may be updated at the RAN node based on reception of the message, the meta information update response message including the applicability information.

In some examples of the method, apparatuses, and non-transitory computer-readable medium described herein, the logical function includes at least one of an operation and maintenance (OAM) function or a service management and orchestration (SMO) function.

In some examples of the method, apparatuses, and non-transitory computer-readable medium described herein, receiving the message may include operations, features, means, or instructions for receiving the message including the meta information for the ML model based on the ML model being transparent to the RAN node.

In some examples of the method, apparatuses, and non-transitory computer-readable medium described herein, receiving the message may include operations, features, means, or instructions for receiving the message including the ML model in addition to the meta information for the ML model.

Some examples of the method, apparatuses, and non-transitory computer-readable medium described herein may further include operations, features, means, or instructions for storing the meta information at the RAN node and transmitting, as part of the model management message and to the one or more devices, the meta information for the ML model and the ML model based on storing the meta information at the RAN node, where the control and the management of the ML model at the one or more devices may be in accordance with the meta information.

In some examples of the method, apparatuses, and non-transitory computer-readable medium described herein, receiving the message may include operations, features, means, or instructions for receiving the message including the meta information from an Access and Mobility Management Function (AMF).

In some examples of the method, apparatuses, and non-transitory computer-readable medium described herein, receiving the message may include operations, features, means, or instructions for receiving the message including the meta information via a direct interface from a data collection application function (DCAF).

In some examples of the method, apparatuses, and non-transitory computer-readable medium described herein, receiving the message may include operations, features, means, or instructions for receiving the message including the meta information via an interface from a data collection RAN function (DCRF).

In some examples of the method, apparatuses, and non-transitory computer-readable medium described herein, receiving the message may include operations, features, means, or instructions for receiving the message including the meta information from a user equipment (UE), where the message includes a UE assistance information message.

In some examples of the method, apparatuses, and non-transitory computer-readable medium described herein, the meta information may be identified at the RAN node based on the applicability information for the ML model, the applicability information including an identifier of the ML model, an identifier of the meta information, a version of the meta information, a tag associated with the meta information, or a combination thereof.

A method for wireless communications at a UE is described. The method may include receiving, from an application function, a message including meta information for a ML model supported by the UE and transmitting, to a RAN node, a control message to update the meta information for the ML model at the RAN node, the control message including the meta information for the ML model supported by the UE, where the meta information includes applicability information for control and management of the ML model.

An apparatus for wireless communications at a UE is described. The apparatus may include a processor, memory coupled with the processor, and instructions stored in the memory. The instructions may be executable by the processor to cause the apparatus to receive, from an application function, a message including meta information for a ML model supported by the UE and transmit, to a RAN node, a control message to update the meta information for the ML model at the RAN node, the control message including the meta information for the ML model supported by the UE, where the meta information includes applicability information for control and management of the ML model.

Another apparatus for wireless communications at a UE is described. The apparatus may include means for receiving, from an application function, a message including meta information for a ML model supported by the UE and means for transmitting, to a RAN node, a control message to update the meta information for the ML model at the RAN node, the control message including the meta information for the ML model supported by the UE, where the meta information includes applicability information for control and management of the ML model.

A non-transitory computer-readable medium storing code for wireless communications at a UE is described. The code may include instructions executable by a processor to receive, from an application function, a message including meta information for a ML model supported by the UE and transmit, to a RAN node, a control message to update the meta information for the ML model at the RAN node, the control message including the meta information for the ML model supported by the UE, where the meta information includes applicability information for control and management of the ML model.

Some examples of the method, apparatuses, and non-transitory computer-readable medium described herein may further include operations, features, means, or instructions for receiving, from the RAN node, a request for transmission of the meta information associated with the ML model, the message including the applicability information, where the control message may be transmitted in response to the request.

Some examples of the method, apparatuses, and non-transitory computer-readable medium described herein may further include operations, features, means, or instructions for transmitting, to the RAN node, an indication that the UE may have an update for the meta information, where the message may be received in response to the indication.

Some examples of the method, apparatuses, and non-transitory computer-readable medium described herein may further include operations, features, means, or instructions for transmitting, to the RAN node, a capability message indicating that the UE supports the ML model, the capability message including the applicability information for the control and the management of the ML model.

In some examples of the method, apparatuses, and non-transitory computer-readable medium described herein, the message including the meta information for the ML model may be based on the ML model being transparent to the RAN node.

A method for wireless communications at an AMF is described. The method may include receiving a first message including meta information for a ML model at one or more devices, the meta information including applicability information for control and management of the ML model at a RAN node and transmitting, to the RAN node, a second message including the meta information for the ML model based on the applicability information included in the meta information.

An apparatus for wireless communications at an AMF function is described. The apparatus may include a processor, memory coupled with the processor, and instructions stored in the memory. The instructions may be executable by the processor to cause the apparatus to receive a first message including meta information for a ML model at one or more devices, the meta information including applicability information for control and management of the ML model at a RAN node and transmit, to the RAN node, a second message including the meta information for the ML model based on the applicability information included in the meta information.

Another apparatus for wireless communications at an AMF function is described. The apparatus may include means for receiving a first message including meta information for a ML model at one or more devices, the meta information including applicability information for control and management of the ML model at a RAN node and means for transmitting, to the RAN node, a second message including the meta information for the ML model based on the applicability information included in the meta information.

A non-transitory computer-readable medium storing code for wireless communications at an AMF function is described. The code may include instructions executable by a processor to receive a first message including meta information for a ML model at one or more devices, the meta information including applicability information for control and management of the ML model at a RAN node and transmit, to the RAN node, a second message including the meta information for the ML model based on the applicability information included in the meta information.

Some examples of the method, apparatuses, and non-transitory computer-readable medium described herein may further include operations, features, means, or instructions for receiving, as part of the applicability information, geographical information indicating where the ML model may be applicable, node information where the ML model may be applicable, where the node information includes one or more RAN nodes, the RAN node being identified from the one or more RAN nodes based on the node information.

In some examples of the method, apparatuses, and non-transitory computer-readable medium described herein, the first message including the meta information may be received from one of a network exposure function (NEF) or a meta info management function (MIMF).

In some examples of the method, apparatuses, and non-transitory computer-readable medium described herein, the first message including the meta information may be received from a DCAF.

In some examples of the method, apparatuses, and non-transitory computer-readable medium described herein, the first message including the meta information may be received from a DCRF.

In some examples of the method, apparatuses, and non-transitory computer-readable medium described herein, the ML model may be transparent to the RAN node; and transmission of the second message including the meta information for the ML model may be based on the ML model being transparent to the RAN node.

A method for wireless communications at a DCRF is described. The method may include receiving, from an application service provider, a first message including meta information for a ML model at one or mode devices, the meta information including applicability information for control and management of the ML model at a RAN node and transmitting, to the RAN node, a second message including the meta information for the ML model based on the applicability information included in the meta information.

An apparatus for wireless communications at a DCRF is described. The apparatus may include a processor, memory coupled with the processor, and instructions stored in the memory. The instructions may be executable by the processor to cause the apparatus to receive, from an application service provider, a first message including meta information for a ML model at one or mode devices, the meta information including applicability information for control and management of the ML model at a RAN node and transmit, to the RAN node, a second message including the meta information for the ML model based on the applicability information included in the meta information.

Another apparatus for wireless communications at a DCRF is described. The apparatus may include means for receiving, from an application service provider, a first message including meta information for a ML model at one or mode devices, the meta information including applicability information for control and management of the ML model at a RAN node and means for transmitting, to the RAN node, a second message including the meta information for the ML model based on the applicability information included in the meta information.

A non-transitory computer-readable medium storing code for wireless communications at a DCRF is described. The code may include instructions executable by a processor to receive, from an application service provider, a first message including meta information for a ML model at one or mode devices, the meta information including applicability information for control and management of the ML model at a RAN node and transmit, to the RAN node, a second message including the meta information for the ML model based on the applicability information included in the meta information.

Some examples of the method, apparatuses, and non-transitory computer-readable medium described herein may further include operations, features, means, or instructions for receiving, from the RAN node, a third message including a request for the meta information, where receiving the first message may be in response to the request.

In some examples of the method, apparatuses, and non-transitory computer-readable medium described herein, the first message may be received from the application service provider via an interface configured for communications between a provisioning application function of the application service provider and the DCRF.

In some examples of the method, apparatuses, and non-transitory computer-readable medium described herein, the second message may be transmitted to the RAN node via an interface configured for communications between the DCRF and the RAN node.

### BRIEF DESCRIPTION OF THE DRAWINGS

FIG. 1 shows an example of a wireless communications system that supports meta information signaling for network devices in accordance with one or more aspects of the present disclosure.

FIG. 2 shows an example of a network architecture that supports meta information signaling for network devices in accordance with one or more aspects of the present disclosure.

FIG. 3 shows an example of a wireless communications system that supports meta information signaling for network devices in accordance with one or more aspects of the present disclosure.

FIG. 4 shows an example of a process flow that supports meta information signaling for network devices in accordance with one or more aspects of the present disclosure.

FIG. 5 shows an example of a network architecture that supports meta information signaling for network devices in accordance with one or more aspects of the present disclosure.

FIG. 6 shows an example of a network architecture that supports meta information signaling for network devices in accordance with one or more aspects of the present disclosure.

FIG. 7 shows an example of a process flow that supports meta information signaling for network devices in accordance with one or more aspects of the present disclosure.

FIG. 8 shows an example of a process flow that supports meta information signaling for network devices in accordance with one or more aspects of the present disclosure.

FIGS. 9 and 10 show block diagrams of devices that support meta information signaling for network devices in accordance with one or more aspects of the present disclosure.

FIG. 11 shows a block diagram of a communications manager that supports meta information signaling for network devices in accordance with one or more aspects of the present disclosure.

FIG. 12 shows a diagram of a system including a device that supports meta information signaling for network devices in accordance with one or more aspects of the present disclosure.

FIGS. 13 and 14 show block diagrams of devices that support meta information signaling for network devices in accordance with one or more aspects of the present disclosure.

FIG. 15 shows a block diagram of a communications manager that supports meta information signaling for network devices in accordance with one or more aspects of the present disclosure.

FIG. 16 shows a diagram of a system including a device that supports meta information signaling for network devices in accordance with one or more aspects of the present disclosure.

FIGS. 17 through 24 show flowcharts illustrating methods that support meta information signaling for network devices in accordance with one or more aspects of the present disclosure.

### DETAILED DESCRIPTION

In some wireless communications systems, a user equipment (UE) may implement one or more machine learning (ML) models to assist in the performance of operations at the UE. For example, the UE may implement a ML model to perform beam pair prediction, assist in forecasting channel measurement, or predict interference among various other operations. Each ML model deployed at the UE may have multiple parameters (e.g., different programming weights, input parameters, output parameters), which may be adjusted to improve the performance of the ML model. As such, a radio access network (RAN) node serving the UE may activate, deactivate, or adjust the parameters of the one or more models based on meta information (e.g., configurations of the UE, geographical area associated with the UE, operating bandwidth part (BWP), operating subcarrier spacing, or the like).

In some cases, the UE may receive, or otherwise implement, a ML model from an application function (e.g., application server) that is separate from (e.g., not coupled with) the RAN node, thereby making the ML model transparent to the RAN node. In such cases, however, if the ML model is transparent to the RAN node, the RAN node may not have an indication of which ML model is being implemented at the UE, nor have an indication of the meta information associated with the ML model. As such, the RAN node may not be able to activate, deactivate, or adjust (e.g., manage) the parameters of the ML model, leading to less efficient coordination between the UE and the RAN node.

The techniques described herein may enable the RAN node to receive meta information for a ML model, where the ML model may be transparent to the RAN node. In one example, an application function that provides the ML model to the UE may indicate such meta information to one or more logical functions of a Cellular Core Network, a Non-Real Time RAN intelligent Controller (Non-RT RIC), or a Near Real Time RIC (Near-RT RIC), such as a network exposure function (NEF), a data collection application function (DCAF), operations and maintenance (OAM) function, or a service management and orchestration (SMO) function. In some examples, logical functions may provide the meta information to an access and mobility management function (AMF), where the AMF may forward such information to the RAN node. For example, the OAM or SMO may directly provide the meta information to the RAN node.

Additionally, or alternatively, the cellular network may be configured to implement a direct interface between the DCAF and the RAN node, such that in response to receiving the meta information from the application server, the DCAF may provide the meta information directly to the RAN node. In some examples, the cellular network may be configured to implement a data collection RAN function (DCRF), where such DCRF may directly interface with the RAN node and be configured to provide the meta information to the RAN node. In some other examples, the UE operating the ML model may provide the meta information directly to the RAN node via a Uu interface.

In this way, the RAN node may receive the meta information for a ML model that may be transmitted to the UE transparent to (over the top of) the RAN node, thereby enabling the RAN node to control and manage the ML model at the UE. Such techniques may result in improved coordination between the UE and the RAN node and provide for efficient communication methods between various logic functions of the network.

Aspects of the disclosure are initially described in the context of wireless communications systems. Aspects of the disclosure are further described in relation to process flows and network architectures. Aspects of the disclosure are further illustrated by and described with reference to apparatus diagrams, system diagrams, and flowcharts that relate to meta information signaling for network devices.

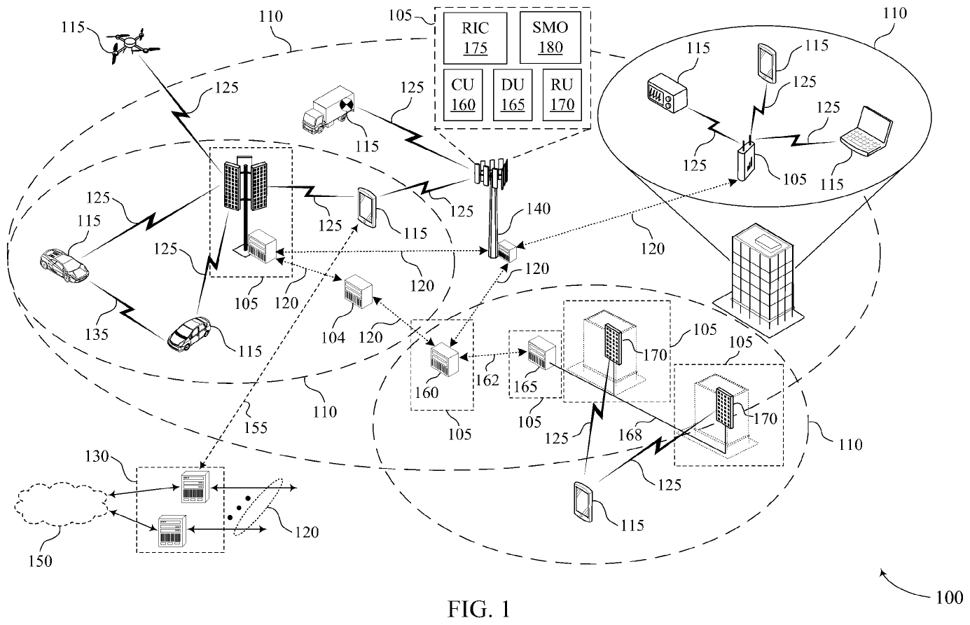

FIG. 1 shows an example of a wireless communications system 100 that supports meta information signaling for network devices in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a RAN node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-RT RIC, a Non-RT RIC), a SMO 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUS 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (VIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support meta information signaling for network devices as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a BWP) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an AMF and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHZ.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some wireless communications systems, the UE 115 may implement one or more ML models to assist in the performance of respective operations at the UE 115. For example, the UE 115 may implement a ML mode to perform beam pair prediction, assist in channel measurement and forecasts, among other operations. Each ML model deployed at the UE 115 may have multiple parameters (e.g., different programming weights), which may be adjusted to improve the performance of the model. As such, a RAN node (e.g., network entity 105) serving the UE 115 may activate, deactivate, or adjust the parameters of the one or more ML models based on meta information (e.g., configurations, geographical area, bandwidth part, subcarrier spacing, or the like) associated with each ML model.

In some cases, the UE 115 may receive, or otherwise implement, a ML model from an application function (e.g., application server) that is separate from (e.g., not coupled with) a RAN node (e.g., a network entity 105 or one or more components of the network entity 105), thereby making the model transparent to the RAN node. In such cases, however, if the model is transparent to the RAN node, the RAN node may not have an indication of which ML model is being implemented at the UE 115, nor have an indication of the meta information associated with the ML model. As such, the RAN node may not be able to activate, deactivate, or adjust (e.g., manage) the parameters of the model, leading to less efficient coordination between the UE 115 and the RAN node.

The techniques described herein may enable the RAN node to receive meta information associated with a ML model, where the ML model is transparent to the RAN node. In one example, an application function that provides the ML model to the UE 115 may indicate such meta information to one or more logical functions of a Cellular Core Network, a Non-RT RIC, or Near-RT RIC, such as a NEF, a DCAF, OAM function, or a SMO function. In some examples, the logical functions may provide the meta information to an AMF, where the AMF then forwards such information to the RAN node. In some other examples, the logical functions, such as a SMO or an OAM, may directly provide the meta information to RAN nodes.

Additionally, or alternatively, the network may be configured to implement a direct interface between the DCAF and the RAN node, such that in response to receiving the meta information from the application server, the DCAF may provide the meta information directly to the RAN node. In some examples, the network may be configured to implement a DCRF, where such DCRF may directly interface with the RAN node and be configured to provide such meta information to the RAN node. In some other examples, the UE 115 operating the model may provide such meta information directly to the RAN node via a Uu interface.

In this way, the RAN node may receive the meta information associated with a ML model that may be transparent to the RAN node, thereby enabling the RAN node to control and manage the ML model at the UE 115. Such techniques may result in improved coordination between the UE 115 and the RAN node and provide for efficient communication methods between various logic functions of the network.

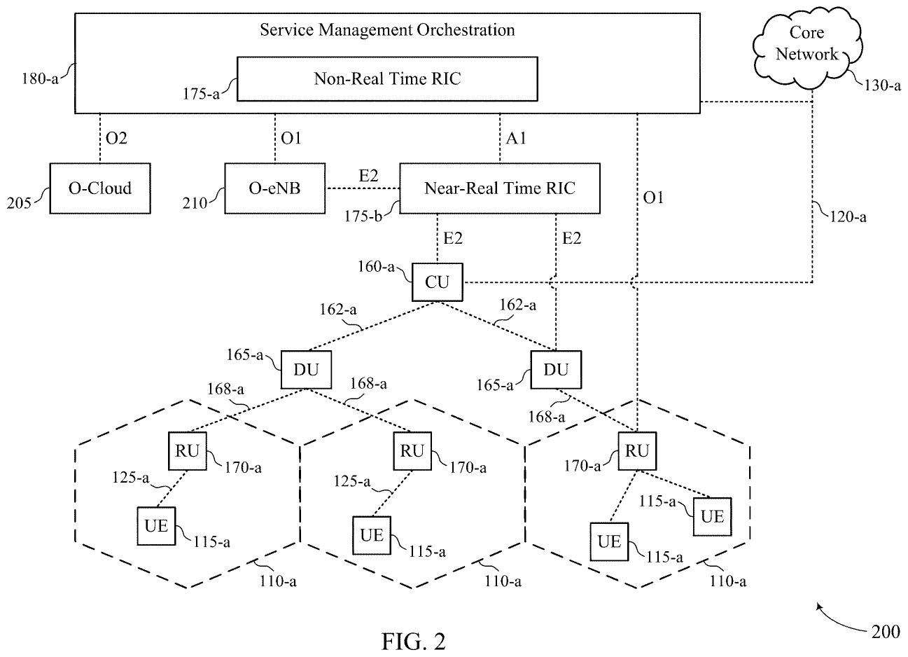

FIG. 2 shows an example of a network architecture 200 (e.g., a disaggregated base station architecture, a disaggregated RAN architecture) that supports meta information signaling for network devices in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an OAM interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an Ol interface). Additionally, or alternatively, in some implementations, the SMO 180-a may communicate directly with one or more RUs 170-a via an Ol interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or ML workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

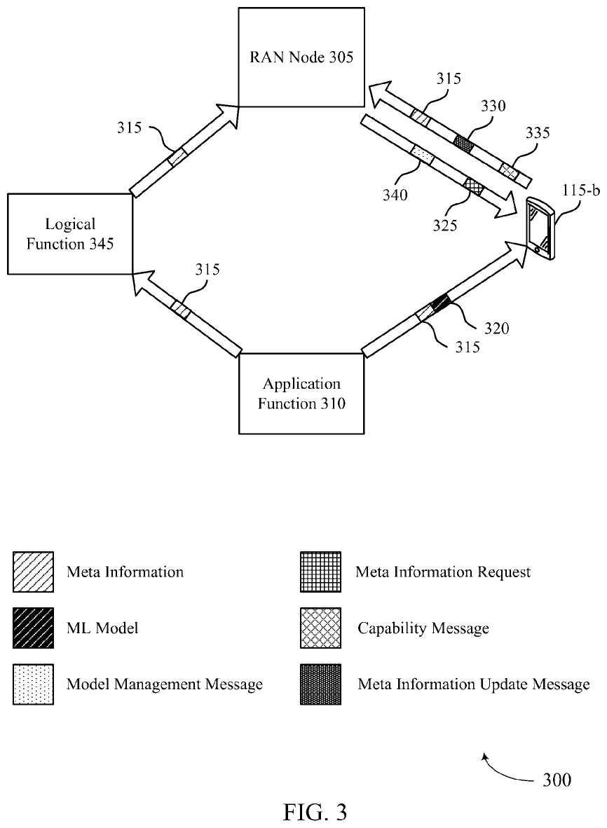

FIG. 3 shows an example of a wireless communications system 300 that supports meta information signaling for network devices in accordance with one or more aspects of the present disclosure. Aspects of the wireless communications system 300 may implement, or be implemented by, aspects of the wireless communications system 100 and the network architecture 200 as described herein with reference to FIGS. 1 and 2. For example, the wireless communications system 300 may include a UE 115-b, which may be an example of corresponding UEs 115 described herein. Further, the wireless communications system 300 may include a RAN node 305, which may be an example of a network entity 105 as described herein. Aspects of the wireless communications system 300 may enable the RAN node 305 to receive meta information 315 for a ML model 320, where the ML model 320 may be transparently delivered to the UE 115-b by an application function 310.

In some cases, the UE 115-b may implement one or more ML models 320 to assist in the performance of one or more operations at the UE 115-b. In AI/ML based procedures, various ML models 320 (e.g., model structures) may be defined per ML feature and functionality (e.g., ML function name). That is, a first ML model 320 configured for a first operation (e.g., such as beam pair prediction) at the UE 115-b may be different from a second ML model 320 configured for a second operation (e.g., such as forecasting channel measurements or interference) at the UE 115-b. The ML model 320 (e.g., a single ML structure) may include multiple parameter sets (e.g., different weights) that may be adjusted or configured to improve performance of the ML model 320 at the UE 115-b. As such, different ML models 320 configured for different operations or purposes may have respective parameter sets, where such parameter sets may be adjusted in order to improve the performance of the various ML models 320 at the UE 115-b.

In some cases, the UE 115-b and the RAN node 305 may implement the ML model 320 based on the meta information 315. For example, UE 115-b, RAN node 305, or both may select, or otherwise identify, the ML model 320 from various other ML models 320 based on the meta information 315 for the ML model 320. Such meta information 315 may include the scenario (e.g., operation to be performed) at the UE 115-b, a configuration (e.g., capability, battery level, or the like) at the UE 115-b, settings at the UE 115-b, an operating zone (e.g., geographical area) of the UE 115-b, an operating subcarrier spacing at the UE 115-b, a quantity of reception antennas at the UE 115-b, a quantity of transmission antennas at the UE 115-b, carrier information associated with the channel between the RAN node 305 and the UE 115-b, an operating BWP at the UE 115-b, vendor information of the UE 115-b, vendor information of the RAN node 305, or a combination thereof. Based on selection of the ML model 320, the RAN node 305 may further use such meta information 315 to control and manage the ML model 320 at the UE 115-b. For example, based on the meta information 315, the RAN node 305 may activate the ML model 320, deactivate the ML model 320, or adjust one or more parameter sets of the ML model 320.

The UE 115-b may receive the ML model 320 via various model delivery methods. In some cases, the ML model 320 may be transferred (e.g., delivered) between the UE 115-b and the RAN node 305 via a control plane messaging, user plane messaging, or both using radio resource control (RRC) signaling. That is, the RAN node 305 may transmit, to the UE 115-b, a RRC message indicating which ML model 320 to implement at the UE 115-b. In some other cases, the ML model 320 may be transferred between the UE 115-b and a core network (e.g., excluding a location management function (LMF)) via control plane functions and user plane functions of the core network. That is, the core network may indicate, to the UE 115-b, to implement the ML model 320 via control plane functions, user plane functions, or both. In some other cases, the ML model 320 may be transferred between the UE 115-b and the LMF via control plane functions and user plane functions. That is, the LMF may indicate, to the UE 115-b, to implement the ML model 320 via control plane functions, user plane functions, or both.

In some cases, the ML model 320 may be transferred between the UE 115-b and the application function 310 (e.g., otherwise referred to as an application server).

For example, the UE 115-b may receive, or otherwise implement, the ML model 320 from the application function 310, where the application function 310 may be separate from (e.g., not coupled with) the RAN node 305, thereby making the ML model 320 transparent (e.g., not known) to the RAN node 305. As such, the RAN node 305 may not have an indication of which ML model 320 may be implemented at the UE 115-b, nor have an indication of the meta information 315 associated with the ML model 320.

In such cases, however, if the ML model 320 and the meta information 315 are transparent to the RAN node 305, the RAN node 305 may not be able to control or manage the ML model 320 at the UE 115-b, resulting in decreased coordination between devices. Such decreased coordination between the UE 115-b and the RAN node 305 may lead to communication mismatches, increased latency, or both.

The techniques described herein may enable the RAN node 305 to receive the meta information 315 for a ML model 320, where the ML Model 320 is delivered to the UE 115-b transparent to (e.g., over-the-top of) the RAN node 305. In some examples, the RAN node 305 may receive the meta information 315 through collaboration between vendors of the application function 310 and vendors of the RAN node 305. As an illustrative example, the vendor of the application function 310 may collaborate with the vendor of the RAN node 305 in order to implement one or more interfaces between the application function 310 and the RAN node 305, such that the meta information 315 may be provided to the RAN node 305.

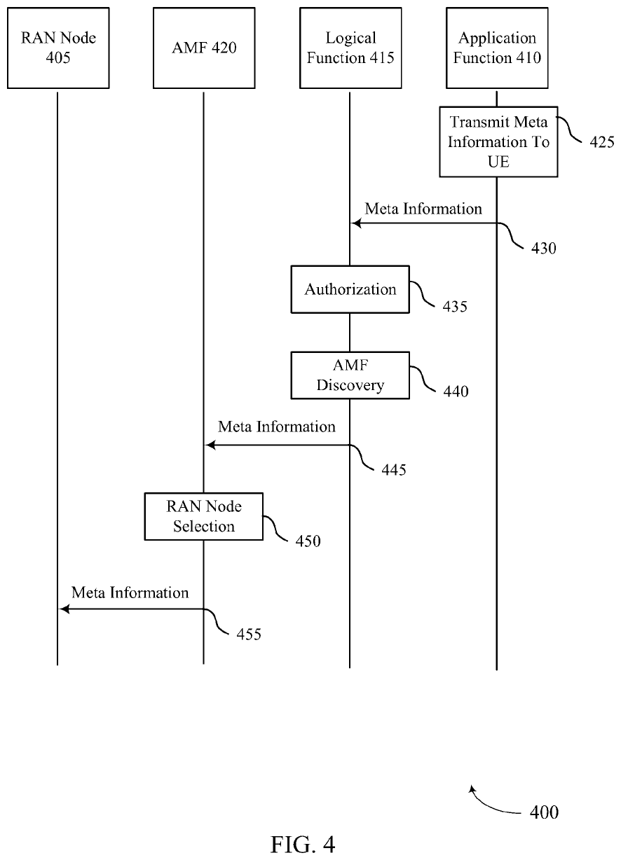

In some examples, the RAN node 305 may receive the meta information 315 via the application function 310 (e.g., by edge applications). For example, in response to transmitting the ML model 320 and the meta information 315 to the UE 115-b, the application function 310 may also indicate the meta information 315 to a logical function 345 of the core network, such as a NEF or a meta info management function (MIMF). In response, the logical function 345 may authenticate (e.g., authorize) the communications with the application function 310 based on the meta information 315 and perform an AMF discovery procedure to identify the AMF associated with the RAN node 305. Based on authenticating the application function 310 and identifying the AMF, the logical function 345 may transmit the meta information 315 to the identified AMF, where the AMF may identify the RAN node 305 associated with the meta information 315. In this way, the AMF may forward the meta information 315 to the RAN node 305. Such techniques may be further described herein with reference to FIG. 4.

In some examples, the RAN node 305 may receive the meta information 315 via an event exposure (EVEX) framework of the core network. For example, in response to transmitting the ML model 320 and the meta information 315 to the UE 115-b, the application function 310 may also indicate the meta information 315 to the logical function 345, which may be an example of a DCAF of the core network.

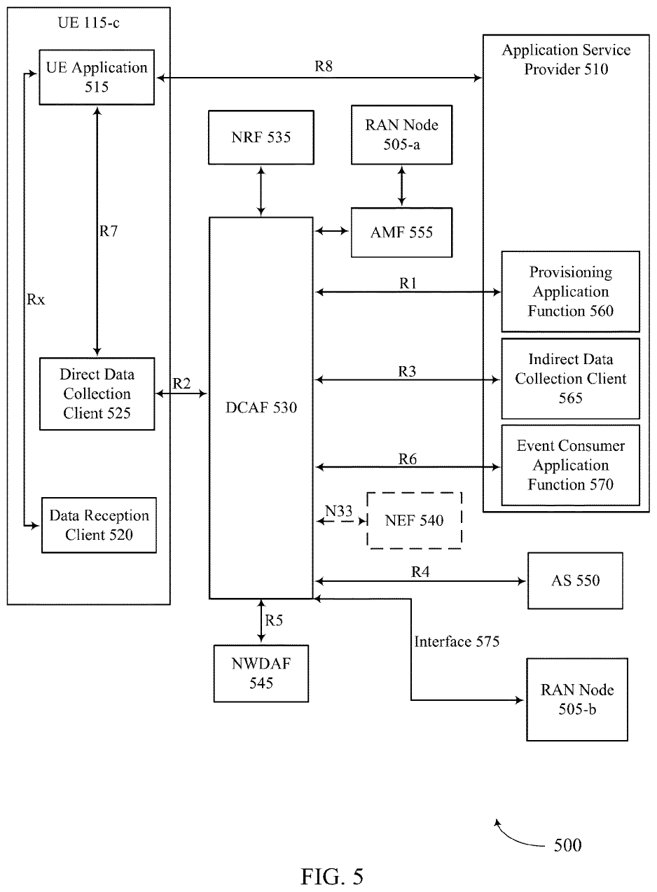

Additionally, or alternatively, the UE 115-b may indicate the meta information 315 to the DCAF. As such, the DCAF (e.g., the logical function 345) may deliver (e.g., transmit or indicate) the meta information 315 to an AMF associated with the RAN node 305, where the AMF may forward the meta information 315 to the RAN node 305. Additionally, or alternatively, the DCAF may be configured to communicate directly with the RAN node 305 (e.g., without first interfacing with the AMF). For example, the core network may be configured to implement a direct interface between the DCAF and the RAN node 305, such that in response to receiving the meta information 315 from the application function 310 or the UE 115-b, the DCAF may provide the meta information directly to the RAN node 305. Such techniques may be further described herein with reference to FIG. 5.

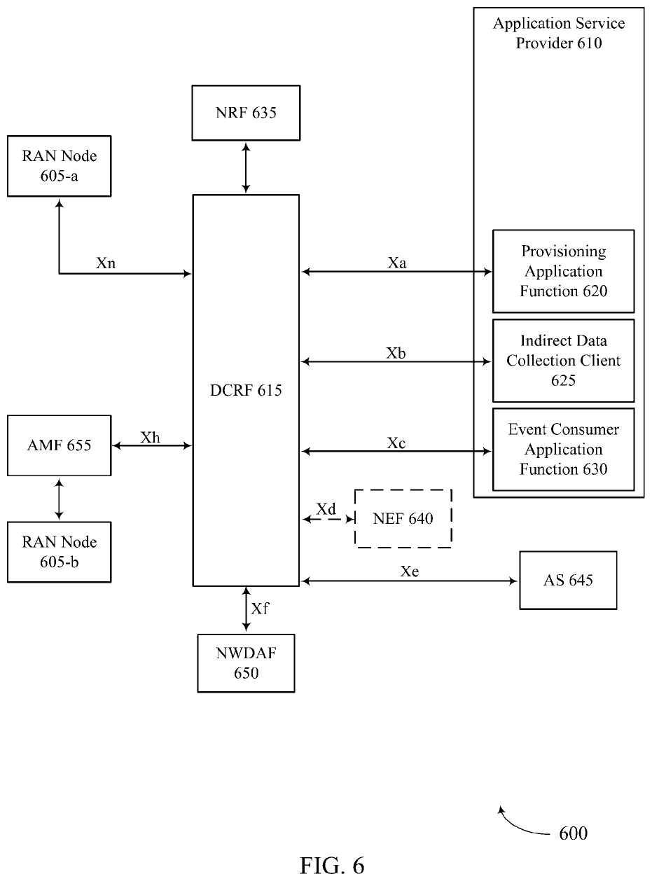

In some examples, the RAN node 305 may receive the meta information 315 via a DCRF (e.g., the logical function 345) implemented in the core network. For example, the core network may be configured to implement the DCRF, where such DCRF may directly interface with the RAN node 305, the application function 310, an AMF associated with the RAN node 305, or a combination thereof. In one example, the DCRF may receive, from the application function 310, the meta information 315 for the ML model 320 and forward the meta information 315 to the RAN node 305 via an interface configured to support communications between the DCRF and the RAN node 305. Additionally, or alternatively, the DCRF may communicate with the AMF associated with the RAN node 305. As such, the DCRF may forward the meta information 315 to the AMF associated with the RAN node 305, where the AMF may then transmit the meta information 315 to the RAN node 305. Such techniques may be further described herein with reference to FIG. 6.

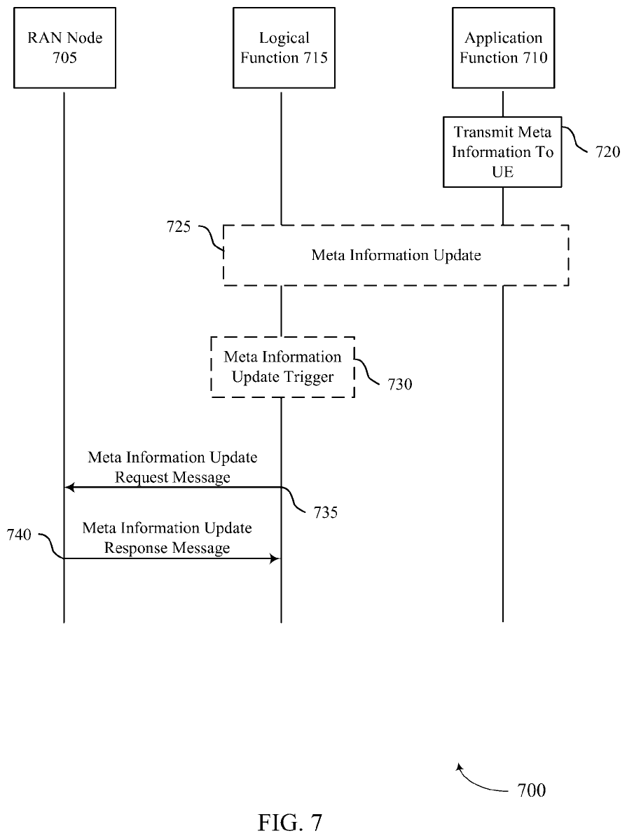

In some examples, the RAN node 305 may receive the meta information 315 from the logical function 345, which may be an example of a SMO function (e.g., such as an SMO 180), an OAM function, or both. For example, when the application function 310 transmits the ML model 320 or updates the meta information 315 at the UE 115-b, an application associated with ML model 320 (e.g., rAPP) of the SMO (e.g., the logical function 345) may be triggered, where such application (e.g., rAPP) may have access to the meta information 315 associated with the ML model 320. In response to the application (e.g., rAPP) being triggered, the SMO may transmit the meta information 315 to the RAN node 305. Additionally, or alternatively, the application function 310 may transmit the meta information 315 to the OAM function (e.g., the logical function 345) of the core network, where the OAM function may provide the meta information 315 to the RAN node 305. Such techniques may be further described herein with reference to FIG. 7.

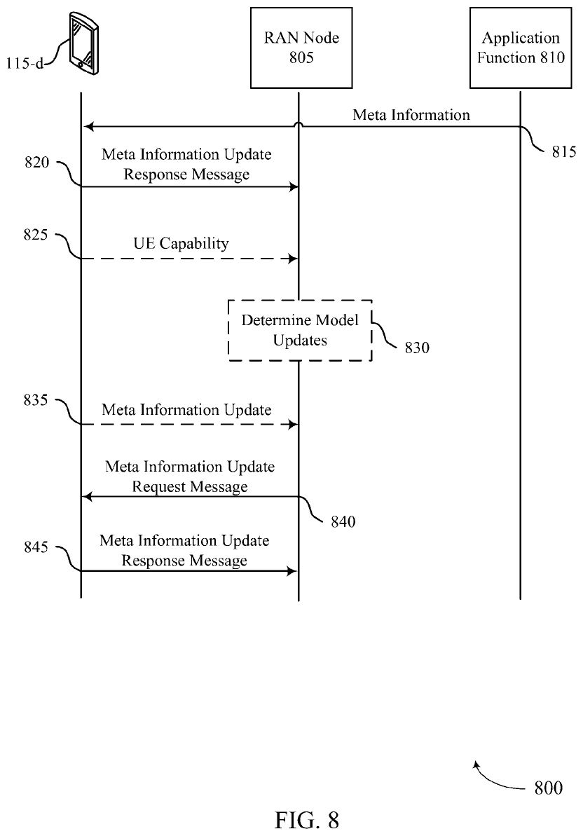

In some examples, the RAN node 305 may receive the meta information 315 from the UE 115-b via a Uu interface. In one example, the UE 115-b may autonomously transmit the meta information 315 to the RAN node 305 in response to receiving the meta information 315 and the ML model 320 or an update to the meta information 315 from the application function 310. In another example, the RAN node 305 may transmit a meta information request message 325 that requests for the UE 115-b to provide the meta information 315 to the RAN node 305. In such examples, the RAN node 305 may transmit the meta information request message 325 in response to receiving a meta information update message 330 from the UE 115-b. Further, the RAN node 305 may transmit the meta information request message 325 in response to receiving a UE capability message 335 from the UE 115-b, where the UE capability message 335 indicates that the UE 115-b supports one or more ML models 320. Such techniques may be further described herein with reference to FIG. 8.

In such examples, the meta information 315 may be formatted using a first format, such that the RAN node 305 may be able to decode and receive the meta information 315. Further, the techniques described herein may be used to provide updated meta information 315 to the RAN node 305. Based on receiving the meta information 315 from the logical function 345 or the UE 115-b, the RAN node 305 may transmit a model management message 340 instructing the UE 115-b to perform one or more model management operations for the ML model 320. For example, based on the meta information 315, the RAN node 305 may indicate for the UE 115-b to activate the ML model 320 at the UE 115-b, suspend the ML Model 320 for a duration of time, deactivate the ML model 320, adjust one or more parameters of the ML model 320, switch between a first ML model 320 to a second ML model 320, or a combination thereof.

Using the techniques described herein, the RAN node 305 may receive the meta information 315 for the ML model 320, where the ML model 320 may be transparent to the RAN node 305. As such, the RAN node 305 may be able to transmit the model management message 340 instructing the UE 115-b to perform one or more model operations (e.g., control and manage the ML model) based on the meta information. In this way, the UE 115-b and the RAN node 305 may improve coordination, decrease ML and communication mismatches, or both.

FIG. 4 shows an example of a process flow 400 that supports meta information signaling for network devices in accordance with one or more aspects of the present disclosure. Aspects of the process flow 400 may implement, or be implemented by, aspects of the wireless communications system 100, the network architecture 200, and the wireless communications system 300 as described herein with reference to FIGS. 1 through 3. For example, the process flow 400 may include a RAN node 405 and an application function 410, which may be examples of a RAN node 305 and an application function 310 as described herein with reference to FIG. 3. Further, the process flow 400 may include a logical function 415 (e.g., such as an NEF or MIMF) and an AMF 420. The techniques described in the context of the process flow 400 may be implemented to enable the RAN node 405 to receive meta information for a ML model operated by a UE (not shown) from edge applications (e.g., the application function 410), where the ML model may be transparent to the RAN node 405.

For example, at 425, the application function 410 may transmit a message that includes the meta information for the ML model supported at the UE, where the ML model may be transmitted to the UE transparent to (e.g., over-the-top of) the RAN node 405. In some other examples, the application function 410 may update the meta information for a model at the UE, where the updated meta information may also be transparent to the RAN node 405.

At 430, the application function 410 may transmit a message (e.g., such as an application function service invoke message) to the logical function 415, where the message includes the meta information (e.g., or updated meta information) for the ML model operated by the UE. In some examples, the logical function may be a MIMF. In such examples, the MIMF may store the meta information in the core network and provide the meta information to one or more network functions within the core network. In some other examples, the logical function may be a NEF, where the NEF may be configured to provide the meta information to one or more network functions within the core network.

In some examples, the application function 410 may include applicability information in the meta information, where such applicability information may be for the control and management of the ML model by the RAN node 405. Such applicability information may include one or more of an identifier of the ML model at the UE, a list of identifiers of various ML models at the UE (e.g., if multiple ML models are implemented at the UE), an identifier of the meta information, a version of the meta information (e.g., identifying each iteration or update of the meta information), a tag associated with the meta information, or a combination thereof.

Further, in some examples, the applicability information may include geographical information indicating a physical location of where the ML model is applicable (e.g., where the UE operating the ML model may be located). Such geographical information may include a longitude and latitude and identifier of a public land mobile network (PLMN) that is servicing the UE, a tracking area and identifier of the PLMN serving the UE, or both. Additionally, or alternatively, the applicability information may include node information indicating where the ML model is applicable. That is, the node information may include an identifier of a PLMN and an identifier of the RAN node 405 that is servicing the UE.

In some examples, in order to transmit the message (e.g., application function service invoke message) to the logical function 415 (e.g., MIMF or NEF), the application function 410 and the logical function 415 may implement one or more non-UE specific services, operations, or application program interfaces (API), where such non-UE specific services, operations, or APIs may be based on, or identified from, an identifier of the ML model, an identifier of the RAN node 405, or both. For example, using current techniques, one or more services offered by the application function 410 may be defined for, or otherwise be associated with, a UE or a group of UEs. However, in order to interface the application function 410 with the logical function 415, the application function 410 and logical function 415 may implement various services associated with ML models or associated with the RAN node 405. As such, the application function 410 may provide the meta information to the logical function 415, where such service (e.g., provision of the meta information) may be defined by, or associated with, an identifier of the ML model at the UE, an identifier of the RAN node 405, or both.

At 435, in response to receiving the message (e.g., application service invoke message) including the meta information from the application function 410, the logical function 415 may perform an authorization procedure to determine whether the application function 410 is authorized to provide or update meta information for a ML model at the UE. For example, using current techniques, the logical function 415 may authorize the application function 410 to provide data to the core network on a user basis (e.g., per identifier of the UE). Thus, in order to achieve authorization for the application function 410 to provide the meta information to the logical function 415, the logical function 415 may authorize the application function 410 to communicate with the core network based on the identifier of the ML model associated with the meta information. In this way, the logical function 415 may authorize the application function 410 based on the identifier of the ML model associated with the meta information. As such, the logical function 415 may store a list of identifiers associated with approved (e.g., authenticated) ML models that may be operated at the UE.

At 440, in response to authorizing the application function 410, the logical function (e.g., NEF or MIMF) may perform an AMF discovery procedure to map the geographical information indicated in the meta information to a tracking area associated with the RAN node 405. For example, based on the latitude and longitude, identifier of the PLMN, or both, the logical function 415 may identify the tracking area associated with the RAN node 405 and identify the AMF 420 associated with the tracking area. The logical function 415 may perform the AMF discovery procedure if the tracking area of the RAN node 405 is not provided in the meta information.

At 445, the logical function 415 may transmit, to the AMF 420, a second message (e.g., AMF service invoke message) that includes the meta information for the ML model at the UE. In such examples, the meta information may include the tracking area identified by the logical function 415 at 440. At 450, the AMF 420 may perform a RAN node selection procedure to identify, or otherwise determine, the RAN node 405 associated with the meta information. In such examples, the AMF 420 may identify the RAN node 405 out of multiple RAN nodes 405 based on the tracking area indicated in the meta information, the identifier of the RAN node 450 indicated in the node information, or both.

At 455, in response to identifying the RAN node 405, the AMF 420 may transmit the meta information to the RAN node 405. In this way, the RAN node 405 may control or manage the ML model based on the meta information received from the AMF 420. For example, a life cycle management (LCM) function associated with the RAN node 405 may monitor the performance of the ML model, adjust, deactivate, or activate (e.g., perform events) the ML model at the UE based on the received meta information.

Using the techniques described herein, the RAN node 405 may receive the meta information for the ML model, where the ML model may be transparent to the RAN node 405. As such, the RAN node 405 may be able to transmit a model management message instructing the UE to perform one or more model operations (e.g., control and manage the ML model) based on the meta information. In this way, the UE and the RAN node 405 may improve coordination, decrease ML and communication mismatches, or both.

FIG. 5 shows an example of a network architecture 500 that supports meta information signaling for network devices in accordance with one or more aspects of the present disclosure. Aspects of the network architecture 500 may implement, or be implemented by, aspects of the wireless communications system 100, the network architecture 200, the wireless communications system 300, and the process flow 400 as described herein with reference to FIGS. 1 through 4. For example, the network architecture 500 may include a UE 115-c, a RAN node 505-a, and a RAN node 505-b, which may be examples of corresponding devices described herein. The techniques described in the context of the network architecture 500 may enable the RAN node 505 to receive meta information for a ML model via an EVEX framework of the core network, where the ML model is transparent to the RAN node 505.

In some cases, an application service provider 510 (e.g., vendor of one or more applications, ML models, services, or the like) may communicate with the UE 115-c via an R8 interface. For example, the application service provider 510 may communicate one or more services (e.g., applications) to be implemented at a UE application 515 of the UE 115-c. In such examples, the UE 115-c may implement various logical functions to assist in the performance of the one or more services. For example, the UE application 515 may communicate data associated with the one or more services with a data reception client 520 via an Rx interface of the UE 115-c. Further, the UE application 515 may communicate (e.g., transmit or receive) data associated with the one or more services with a direct data collection client 525 via an R7 interface. In this way, the UE 115-c may implement and perform the one or more services from an application service provider 510.

Further, the application service provider 510 and the UE 115-c may communicate with a DCAF 530 of the core network, where the DCAF 530 may be implemented in order to collect data from various devices and logical functions of the core network. For example, the DCAF 530 may communicate with, and collect data from, a network repository function (NRF) 535, a NEF 540 via an N33 interface, a network data application function (NWDAF) 545 via an R5 interface, various application services (AS) 550 via an R4 interface, an AMF 555, or a combination thereof. Further, the DCAF 530 may communicate with, and collect data from, various components of the application service provider 510. For example, the DCAF may communicate with a provisioning application function 560 via an R1 interface, an indirect data collection client 565 via an R3 interface, an event consumer application function 570 via an R6 interface, or a combination thereof. Further, the DCAF 530 may communicate with the direct data collection client 525 of the UE 115-c via an R2 interface. As such, the DCAF 530 may be implemented to collect data from the various devices and logical functions operating in the core network and forward the data to the intended recipients in the core network via the various interfaces.

In some cases, the application service provider 510 may provide, via the R8 interface, a ML model to be used by the UE application 515 at the UE 115-c. The UE application 515 of the UE 115-c may use the ML model to perform one or more operations at the UE 115-c. In some cases, the application service provider 510 may transmit the ML model to the UE 115-c transparent to (e.g., over-the-top of) the RAN node 505. That is, the RAN node 505 may not have an indication that the UE 115-c is to implement the ML model, nor have an indication of meta information for the ML model. As such, the RAN node 505 may not be able to control and manage the ML model at the UE 115-c, resulting in the decreased coordination between devices.

The techniques described herein may enable the RAN node 505 to receive the meta information using the EVEX framework (e.g., via the DCAF) of the core network. That is, in response to transmitting the ML model to the UE 115-c, the application service provider 510 may provide the meta information for the ML model to the RAN node via the DCAF 530. In some examples, the DCAF 530 may be configured with an interface 575 (e.g., direct interface) to the RAN node 505. For example, the provisioning application function 560 may transmit the meta information to the DCAF 530 via the R1 interface, where the DCAF 530 may forward the meta information to the RAN node 505-b via the interface 575. In this way, the DCAF 530 may be a direct interface between the application service provider 510 and the RAN node 505-b.

In some other examples, the DCAF 530 may provide the meta information to the RAN node 505-a via the AMF 555. For example, the provisioning application function 560 may transmit the meta information to the DCAF 530 via the R1 interface, where the DCAF 530 may forward the meta information to the AMF 555. In response to receiving the meta information, the AMF forward the meta information to the RAN node 505-a. In such examples, in order to provide the meta information to the AMF 555, the DCAF and the AMF 555 may implement a non-UE specific service, operation, or API, such that the AMF 555 may authorize the transmission of the meta information. As such, the AMF 555 may authorize the service, operation, or API used to perform such transmissions based on an identifier of the ML model included in meta information, an identifier of the RAN node 505-a, or both. Further, in some examples, the AMF 555 may identify the RAN node 505-a based on the identifier of the RAN node 505-a included in the meta information and transmit the meta information to the RAN node 505-a.

Further, the provisioning application function 560 may include applicability information in the meta information, where such applicability information may be for the control and management of the ML model by the RAN node 505. Such applicability information may include one or more of an identifier of the ML model at the UE 115-c, a list of identifiers of various ML models at the UE 115-c (e.g., if multiple ML models are implemented at the UE), an identifier of the meta information, a version of the meta information (e.g., identifying each iteration or update of the meta information), a tag associated with the meta information, or a combination thereof.

Additionally, in some examples, the applicability information may include geographical information indicating a physical location of where the ML model is applicable (e.g., where the UE 115-c operating the ML model may be located). Such geographical information may include a longitude and latitude and identifier of a PLMN that is servicing the UE 115-c, a tracking area and identifier of the PLMN serving the UE 115-c, or both. Additionally, or alternatively, the applicability information may include node information indicating where the ML model is applicable. That is, the node information may include an identifier of a PLMN, an identifier of the RAN node 505 that is servicing the UE 115-c, or both.

Using the techniques described herein, the RAN node 505 may receive the meta information for the ML model, where the ML model may be transparent to the RAN node 505. As such, the RAN node 505 may be able to transmit a model management message instructing the UE 115-c to perform one or more model operations (e.g., control and manage the ML model) based on the meta information. In this way, the UE 115-c and the RAN node 505 may improve coordination, decrease ML and communication mismatches, or both.

FIG. 6 shows an example of a network architecture 600 that supports meta information signaling for network devices in accordance with one or more aspects of the present disclosure. Aspects of the network architecture 600 may implement, or be implemented by, aspects of the wireless communications system 100, the network architecture 200, the wireless communications system 300, the process flow 400, and the network architecture 500 as described herein with reference to FIGS. 1 through 5. The network architecture may include a RAN node 605 and an application service provider 610, which may be examples of corresponding devices described herein. The techniques described in the context of the network architecture 600 may enable the RAN node 605 to receive meta information for a ML via a DCRF 615, where the ML model may be transparent to the RAN node 605.

For example, the application service provider 610 may transmit the ML model to the UE via a direction interface (e.g., R8 interface) between the application service provider 610 and the UE. As such, the RAN node 605 may not have an indication of the ML model, nor an indication of the meta information for the ML model. In some implementations, the core network may implement a DCRF 615, such that the DCRF may provide an interface between the application service provider 610 and various logical functions and entities of the core network. For example, the DCRF 615 may provision (e.g., support, authorize, or the like) non-UE specific services, operations, or APIs for the core network, such that various logic functions may receive data associated with non-UE specific services.

In some examples, the DCRF 615 may be the interface between the application service provider 610 and the RAN node 605 for the configuration and collection of data from the RAN node 605. For example, the application service provider 610 may configure the DCRF 615, such that the DCRF 615 may provide data from the application service provider 610 to the RAN node 605 and also collect data from the RAN node 605 to provide to the application service provider 610. In such examples, the DCRF 615 may be configured to collect (e.g., consume) data from one or more functions of the application service provider 610. For example, the DCRF 615 may be configured to communicate with a provisioning application function 620 via an Xa interface, with an indirect data collection client 625 via an Xb interface, with an event consumer application function 630 via an Xc interface, or a combination thereof. The DCRF 615 may also be configured to provide such collected data to various logical functions of the core network. For example, the DCRF 615 may communicate data with an NRF 635, an NEF 640 via an Xd interface, an AS 645 via an Xe interface, a NWDAF 650 via an Xf interface, or combination thereof, where such interfaces may be configured for communications with the DCRF 615.

In accordance with the techniques described herein, the application service provider 610 may provide the meta information to the RAN node 605 via the DCRF 615. In some examples, the DCRF 615 may be configured with a Xn interface to the RAN node 605-a, such that the DCRF 615 may provide data to the RAN node 605-a. In such examples, the provisioning application function 620 may provide the meta information for the ML model at the UE to the DCRF 615 via the Xa interface. In response, the DCRF 615 may authorize the communication (e.g., service) of the meta information based on an identifier of the ML model included in the meta information, an identifier of the RAN node 605-a, or both. Based on authorizing the service, the DCRF 615 may transmit, via the Xn interface, the meta information to the RAN node 605-a.

In some other examples, the DCRF 615 may be configured with a Xh interface to the AMF 655, such that the DCRF 615 may provide data to the RAN node 605-b via the AMF 655. In such examples, the provisioning application function 620 may provide the meta information for the ML model at the UE to the DCRF 615 via the Xa interface. In response, the DCRF 615 may authorize the communication (e.g., service) of the meta information based on an identifier of the ML model included in the meta information, an identifier of the RAN node 605-a, or both. That is, the DCRF 615 may provide the non-UE specific service, operation, or API to the application service provider 610, where such non-UE specific service, operation, or API may be based on the identifier of the ML model, identifier of the RAN node 605, or both. Based on authorizing the service, the DCRF 615 may transmit, via the Xh interface, the meta information to the AMF 655. The AMF 655 may identify the RAN node 605-b based on the identifier of the RAN node 605-b included in the meta information and transmit the meta information to the RAN node 605-b.

Further, the provisioning application function 620 may include applicability information in the meta information, where such applicability information may be for the control and management of the ML model by the RAN node 605. Such applicability information may include one or more of an identifier of the ML model at the UE, a list of identifiers of various ML models at the UE (e.g., if multiple ML models are implemented at the UE), an identifier of the meta information, a version of the meta information (e.g., identifying each iteration or update of the meta information), a tag associated with the meta information, or a combination thereof.

Additionally, in some examples, the applicability information may include geographical information indicating a physical location of where the ML model is applicable (e.g., where the UE operating the ML model may be located). Such geographical information may include a longitude and latitude and identifier of a PLMN that is servicing the UE, a tracking area and identifier of the PLMN serving the UE, or both. Additionally, or alternatively, the applicability information may include node information indicating where the ML model is applicable. That is, the node information may include an identifier of a PLMN, an identifier of the RAN node 605 that is servicing the, or both.

Using the techniques described herein, the RAN node 505 may receive the meta information for the ML model, where the ML model may be transparent to the RAN node 505. As such, the RAN node 505 may be able to transmit a model management message instructing the UE to perform one or more model operations (e.g., control and manage the ML model) based on the meta information. In this way, the UE and the RAN node 505 may improve coordination, decrease ML and communication mismatches, or both.

FIG. 7 shows an example of a process flow 700 that supports meta information signaling for network devices in accordance with one or more aspects of the present disclosure. Aspects of the process flow 700 may implement, or be implemented by, aspects of the wireless communications system 100, the network architecture 200, the wireless communications system 300, the process flow 400, the network architecture 500, and the network architecture 600 as described herein with reference to FIGS. 1 through 6. The process flow 700 may include a RAN node 705 and an application function 710, which may be examples of corresponding devices described herein. Further, the process flow 700 may include a logical function 415 (e.g., such as a SMO or an OAM). The techniques described in the context of the process flow 700 may enable the RAN node 705 to receive meta information for a ML model at a UE via the logical function 715, where the ML model may be transparent to the RAN node 705.

For example, at 720, the application function 710 may transmit a ML model and meta information for the ML model to a UE. In such examples, the ML model may be transmitted (e.g., delivered) to the UE transparent to the RAN node 705, such that the RAN node 705 may not have an indication the ML model implemented at the UE, nor have an indication the meta information for the ML model. In some other examples, the application function 710 may update the meta information for a model at the UE, where the updated meta information may also be transparent to the RAN node 705.

At 725, the application function 710 may transmit, to the logical function 715, the meta information (e.g., or updated meta information) as part of a meta information update procedure between the logical function 715 and the application function 710. In such examples, the logical function may be an example of an OAM, where the OAM is configured to provide meta information to the RAN node 705. That is, if the logical function 715 is an OAM, then the OAM may receive the meta information from the application function 710 (e.g., via proprietary methods).

At 730, the logical function 715 may be triggered to provide, or otherwise update, the meta information to the RAN node 705. For example, if the logical function 715 is an SMO, then an application (e.g., rAPP) may be deployed within a Non-RT RIC of the SMO, where such application (e.g., rAPP) may be implemented by the developer (e.g., vendor) of the ML model. As such, in response to the application updating or providing the meta information to the UE, the application (e.g., rAPP) may be triggered to provide the meta information to the RAN node 705, such that a LCM function of the RAN node 705 may use the meta information for control and management of the ML model at the UE.

At 735, the logical function 715 may transmit a meta information update request message requesting the RAN node 705 to update or store the meta information for the ML model at the UE. The meta information update request message may include the meta information, where the meta information may include applicability information for control and management of the ML model. Such applicability information may include one or more of an identifier of the ML model at the UE, a list of identifiers of various ML models at the UE (e.g., if multiple ML models are implemented at the UE), an identifier of the meta information, a version of the meta information (e.g., identifying each iteration or update of the meta information), a tag associated with the meta information, or a combination thereof.

Additionally, in some examples, the applicability information may include geographical information indicating a physical location of where the ML model is applicable (e.g., where the UE operating the ML model may be located). Such geographical information may include a longitude and latitude and identifier of a PLMN that is servicing the UE, a tracking area and identifier of the PLMN serving the UE, or both. Additionally, or alternatively, the applicability information may include node information indicating where the ML model is applicable. That is, the node information may include an identifier of a PLMN, an identifier of the RAN node 705 that is servicing the UE, or both.

In some examples, in addition to the meta information, the meta information update request message may also include the ML model that is to be deployed at the UE. For example, the meta information update request message may include both the meta information and the ML model. In such examples, the RAN node 705 may store (e.g., consume) the meta information associated with the ML model in a memory buffer of the RAN node 705. In response to storing the meta information, the RAN node may transmit, as part of a model management message (e.g., such as the model management message 340), both the meta information and the ML model to the UE, where the meta information may be used for control and management of the ML model at the UE. In some other examples, the meta information for model management and control by the RAN node 705 may be provided separately (from the ML model) to the RAN node 705 (e.g., in accordance with the techniques described herein).

At 740, the RAN node 705 may transmit a meta information update response message indicating that the RAN node 705 has received and updated (e.g., or stored) the meta information for the ML model. In such examples, the RAN node 705 may transmit, as part of the meta information update response message, the meta information and applicability information.

Using the techniques described herein, the RAN node 705 may receive the meta information for the ML model, where the ML model may be transparent to the RAN node 705. As such, the RAN node 705 may be able to transmit the model management message instructing the UE to perform one or more model operations (e.g., control and manage the ML model) based on the meta information. In this way, the UE and the RAN node 705 may improve coordination, decrease ML and communication mismatches, or both.

FIG. 8 shows an example of a process flow 800 that supports meta information signaling for network devices in accordance with one or more aspects of the present disclosure. Aspects of the process flow 800 may implement, or be implemented by, aspects of the wireless communications system 100, the network architecture 200, the wireless communications system 300, the process flow 400, the network architecture 500, the network architecture 600, and the process flow 700 as described herein with reference to FIGS. 1 through 7. The process flow 800 may include a UE 115-d, a RAN node 805, and an application function 810, which may be examples of corresponding devices described herein. The techniques described in the context of the process flow 800 may enable the RAN node 805 to receive meta information for a ML model from the UE 115-d via Uu signaling, where the ML model is transparent to the RAN node 805.

At 815, the application function 810 (e.g., such as an over-the-top server) may transmit a message (e.g., proprietary signaling) including the meta information for the ML model to the UE 115-d. In some examples, UE 115-d may receive the message via an R8 interface or via the EVEX framework (e.g., DCAF) of the core network.

In some examples, the application function 810 may include applicability information in the meta information, where such applicability information may be for the control and management of the ML model by the RAN node 805. Such applicability information may include one or more of an identifier of the ML model at the UE 115-d, a list of identifiers of various ML models at the UE 115-d (e.g., if multiple ML models are to be implemented at the UE 115-d), an identifier of the meta information, a version of the meta information (e.g., identifying each iteration or update of the meta information), a tag associated with the meta information, or a combination thereof.

Further, in some examples, the applicability information may include geographical information indicating a physical location of where the ML model is applicable (e.g., where the UE 115-d operating the ML model may be located). Such geographical information may include a longitude and latitude and identifier of a public land mobile network (PLMN) that is servicing the UE 115-d, a tracking area and identifier of the PLMN serving the UE 115-d, or both. Additionally, or alternatively, the applicability information may include node information indicating where the ML model is applicable. That is, the node information may include an identifier of a PLMN and an identifier of the RAN node 805 that is servicing the UE 115-d.

At 820, the UE 115-d may autonomously transmit a meta information update response message that includes the meta information to the RAN node 805. For example, the UE 115-d may autonomously transmit, to the RAN node 805, the meta information update response message in response to receiving the meta information at 815. The meta information may include the applicability information (e.g., an identifier of the ML model), such that the RAN node 805 may perform control and management of the ML model at the UE 115-d. In some examples, the UE 115-d may transmit the meta information as part of a UE assistance information (UAI) element in an RRC message. That is, the meta information update response message may be an example of UAI in an RRC message.

At 825, the UE 115-d may optionally transmit a UE capability message (e.g., such as the UE capability message 335) indicating an identifier of a supported ML model at the UE 115-d or a list of identifiers of supported ML models at the UE 115-d. The UE 115-d may transmit the UE capability message in response to receiving the meta information from the application function 810 at 815.

At 830, based on reception of the UE capability message, the RAN node 805 may determine whether the RAN node 805 has meta information available for the ML models indicated via the UE capability message at 825. That is, the RAN node 805 may use the identifier or list of identifiers of the supported ML models at the UE 115-d to determine whether the RAN node 805 has meta information associated with each ML model. In some examples, the RAN node 805 may determine that the RAN node 805 does not have meta information (e.g., or up-to-date meta information) for one or more ML models out of the supported ML models indicated in the UE capability message. In such examples, the RAN node 805 may proceed to transmit a meta information update request message at 840.

At 835, the UE 115-d may optionally transmit a message indicating that the UE 115-d has an update to the meta information available for the RAN node 805. In such examples, the UE 115-d may transmit the message in response to receiving the meta information from the application function 810 at 815. In some examples, the message indicating an update is available may be a UAI element in a RRC message. In some examples, the UE 115-d may include identifiers of the ML models in the meta information update message, where the identifiers of the ML models may be associated with updated meta information. In some examples, in response to transmitting the message indicating that the UE 115-d has an update to the meta information, the UE 115-d may autonomously transmit the meta information to the RAN node 805, such that the RAN node 805 may retrieve the updated meta information.

At 840, the RAN node 805 may transmit the meta information update request message to request updated meta information for the ML model or ML models at the UE 115-d. The meta information update request message may be an example of RRC messaging. In some examples, the RAN node 805 may transmit the meta information update request message in response to the determination at 830. In such examples, the RAN node 805 may transmit, via the meta information update request message, one or more identifiers of the ML models associated with the request meta information. That is, if the RAN node 805 determines that the RAN node 805 does not have meta information for one or more ML models at 830, the RAN node 805 may include the identifiers of the one or more ML models in the meta information update request message to the UE 115-d, such that the UE 115-d may identify, and provide, the meta information to the RAN node 805.

In some other examples, the RAN node 805 may transmit the meta information update request message in response to receiving the meta information update message at 835. In such examples, the RAN node 805 may transmit, via the meta information update request message, one or more identifiers of the ML models associated with the request meta information, where the one or more identifiers of ML models correspond with those indicated via the meta information update message at 835. That is, if the UE 115-d includes identifiers of the ML models associated with updated meta information in the meta information update message, then the RAN node 805 may request updated meta information for the ML models indicated via the meta information update at 835.

At 845, in response to the meta information update request message, the UE 115-d may transmit a meta information update response message that includes the meta information to the RAN node 805. That is, the UE 115-d may transmit the meta information for the requested ML models based on the identifiers of the ML models received via the meta information update request message. In some examples, the meta information update response message may be a RRC message.

Using the techniques described herein, the RAN node 805 may receive the meta information for the ML model, where the ML model may be transparent to the RAN node 805. As such, the RAN node 805 may be able to transmit the model management message instructing the UE 115-d to perform one or more model operations (e.g., control and manage the ML model) based on the meta information. In this way, the UE 115-d and the RAN node 805 may improve coordination, decrease ML and communication mismatches, or both.

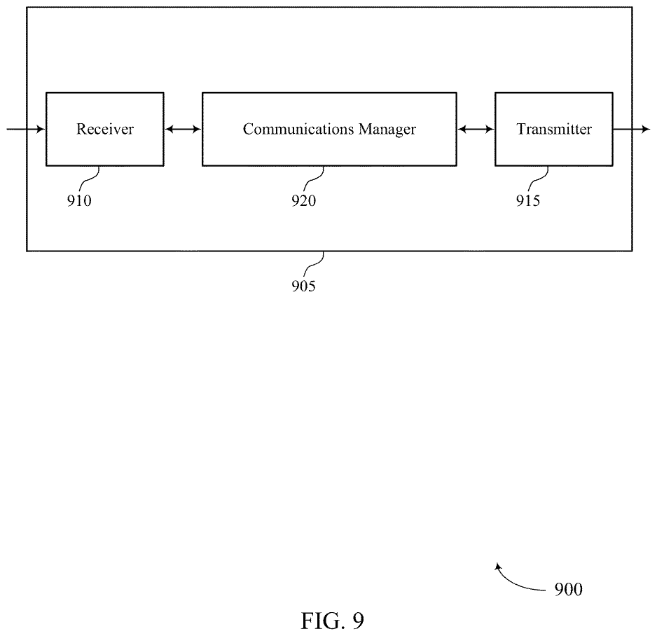

FIG. 9 shows a block diagram 900 of a device 905 that supports meta information signaling for network devices in accordance with one or more aspects of the present disclosure. The device 905 may be an example of aspects of a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of meta information signaling for network devices as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a RAN node in accordance with examples as disclosed herein. For example, the communications manager 920 is capable of, configured to, or operable to support a means for receiving a message including meta information for a ML model at one or more devices, where the RAN node supports communications for the one or more devices, the meta information including applicability information for control and management of the ML model at the RAN node. The communications manager 920 is capable of, configured to, or operable to support a means for transmitting, based on the meta information, a model management message instructing a device of the one or more devices to perform a model management operation for the ML model.

Additionally, or alternatively, the communications manager 920 may support wireless communications at an AMF in accordance with examples as disclosed herein. For example, the communications manager 920 is capable of, configured to, or operable to support a means for receiving a first message including meta information for a ML model at one or more devices, the meta information including applicability information for control and management of the ML model at a RAN node. The communications manager 920 is capable of, configured to, or operable to support a means for transmitting, to the RAN node, a second message including the meta information for the ML model based on the applicability information included in the meta information.

Additionally, or alternatively, the communications manager 920 may support wireless communications at a DCRF in accordance with examples as disclosed herein. For example, the communications manager 920 is capable of, configured to, or operable to support a means for receiving, from an application service provider, a first message including meta information for a ML model at one or mode devices, the meta information including applicability information for control and management of the ML model at a RAN node. The communications manager 920 is capable of, configured to, or operable to support a means for transmitting, to the RAN node, a second message including the meta information for the ML model based on the applicability information included in the meta information.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for enabling a RAN node to receive meta information associated with a ML model at a UE, when the ML model is delivered to the UE transparent to the RAN node, which may result in improved coordination between devices.

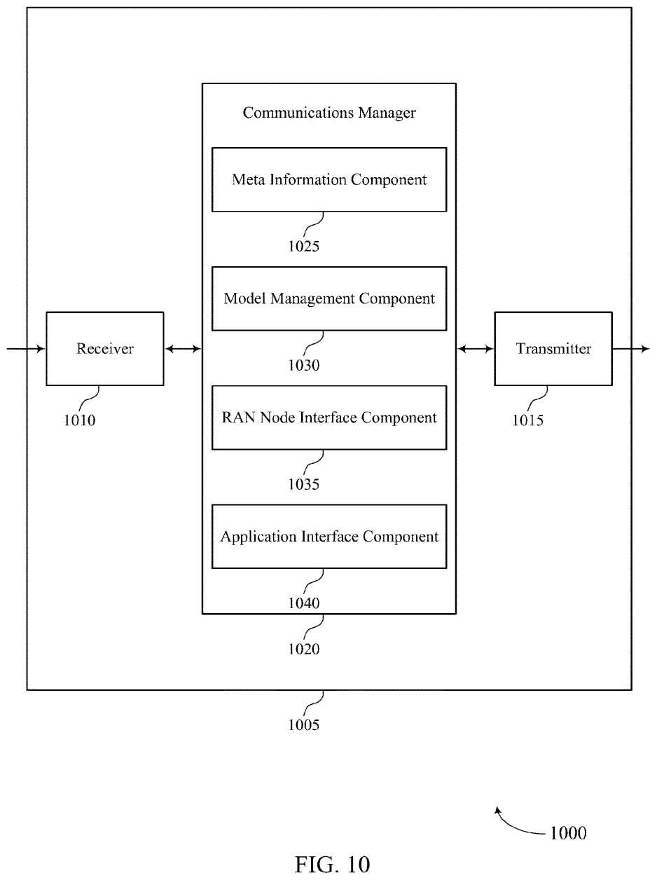

FIG. 10 shows a block diagram 1000 of a device 1005 that supports meta information signaling for network devices in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of meta information signaling for network devices as described herein. For example, the communications manager 1020 may include a meta information component 1025, a model management component 1030, a RAN node interface component 1035, an application interface component 1040, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a RAN node in accordance with examples as disclosed herein. The meta information component 1025 is capable of, configured to, or operable to support a means for receiving a message including meta information for a ML model at one or more devices, where the RAN node supports communications for the one or more devices, the meta information including applicability information for control and management of the ML model at the RAN node. The model management component 1030 is capable of, configured to, or operable to support a means for transmitting, based on the meta information, a model management message instructing a device of the one or more devices to perform a model management operation for the ML model.

Additionally, or alternatively, the communications manager 1020 may support wireless communications at an AMF in accordance with examples as disclosed herein. The meta information component 1025 is capable of, configured to, or operable to support a means for receiving a first message including meta information for a ML model at one or more devices, the meta information including applicability information for control and management of the ML model at a RAN node. The RAN node interface component 1035 is capable of, configured to, or operable to support a means for transmitting, to the RAN node, a second message including the meta information for the ML model based on the applicability information included in the meta information.

Additionally, or alternatively, the communications manager 1020 may support wireless communications at a DCRF in accordance with examples as disclosed herein. The application interface component 1040 is capable of, configured to, or operable to support a means for receiving, from an application service provider, a first message including meta information for a ML model at one or mode devices, the meta information including applicability information for control and management of the ML model at a RAN node. The RAN node interface component 1035 is capable of, configured to, or operable to support a means for transmitting, to the RAN node, a second message including the meta information for the ML model based on the applicability information included in the meta information.

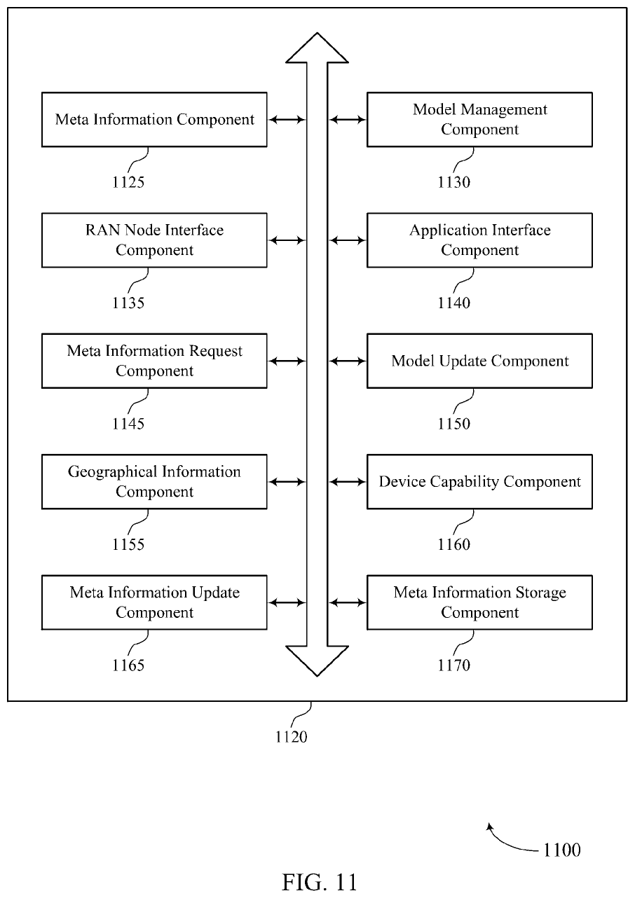

FIG. 11 shows a block diagram 1100 of a communications manager 1120 that supports meta information signaling for network devices in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of meta information signaling for network devices as described herein. For example, the communications manager 1120 may include a meta information component 1125, a model management component 1130, a RAN node interface component 1135, an application interface component 1140, a meta information request component 1145, a model update component 1150, a geographical information component 1155, a device capability component 1160, a meta information update component 1165, a meta information storage component 1170, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications at a RAN node in accordance with examples as disclosed herein. The meta information component 1125 is capable of, configured to, or operable to support a means for receiving a message including meta information for a ML model at one or more devices, where the RAN node supports communications for the one or more devices, the meta information including applicability information for control and management of the ML model at the RAN node. The model management component 1130 is capable of, configured to, or operable to support a means for transmitting, based on the meta information, a model management message instructing a device of the one or more devices to perform a model management operation for the ML model.

In some examples, the meta information request component 1145 is capable of, configured to, or operable to support a means for transmitting, to the one or more devices, a control message requesting the meta information associated with the ML model, the control message including an identifier of the ML model, where the message including the meta information is received from the one or more devices in response to the control message.

In some examples, the device capability component 1160 is capable of, configured to, or operable to support a means for receiving, from the one or more devices, a capability message indicating that the one or more devices support the ML model, the capability message including the applicability information, where transmission of the control message is in response to the capability message.

In some examples, the meta information update component 1165 is capable of, configured to, or operable to support a means for receiving, from the one or more devices, an indication that the one or more devices have an update for the meta information, where transmission of the control message is in response to the indication.

In some examples, the message includes a meta information update request message and is received from a logical function in communication with the RAN node, and the model update component 1150 is capable of, configured to, or operable to support a means for transmitting, to the logical function, a meta information update response message indicating that the meta information associated with the ML model is updated at the RAN node based on reception of the message, the meta information update response message including the applicability information.

In some examples, the logical function includes at least one of an operation and maintenance function or a SMO function.

In some examples, to support receiving the message, the meta information component 1125 is capable of, configured to, or operable to support a means for receiving the message including the meta information for the ML model based on the ML model being transparent to the RAN node.

In some examples, to support receiving the message, the meta information component 1125 is capable of, configured to, or operable to support a means for receiving the message including the ML model in addition to the meta information for the ML model.

In some examples, the meta information storage component 1170 is capable of, configured to, or operable to support a means for storing the meta information at the RAN node. In some examples, the model management component 1130 is capable of, configured to, or operable to support a means for transmitting, as part of the model management message and to the one or more devices, the meta information for the ML model and the ML model based on storing the meta information at the RAN node, where the control and the management of the ML model at the one or more devices is in accordance with the meta information.

In some examples, to support receiving the message, the meta information component 1125 is capable of, configured to, or operable to support a means for receiving the message including the meta information from an AMF.

In some examples, to support receiving the message, the meta information component 1125 is capable of, configured to, or operable to support a means for receiving the message including the meta information via a direct interface from a DCAF.

In some examples, to support receiving the message, the meta information component 1125 is capable of, configured to, or operable to support a means for receiving the message including the meta information via an interface from a DCRF.

In some examples, to support receiving the message, the meta information component 1125 is capable of, configured to, or operable to support a means for receiving the message including the meta information from a UE, where the message includes a UE assistance information message.

In some examples, the meta information is identified at the RAN node based on the applicability information for the ML model, the applicability information including an identifier of the ML model, an identifier of the meta information, a version of the meta information, a tag associated with the meta information, or a combination thereof.

Additionally, or alternatively, the communications manager 1120 may support wireless communications at an AMF in accordance with examples as disclosed herein. In some examples, the meta information component 1125 is capable of, configured to, or operable to support a means for receiving a first message including meta information for a ML model at one or more devices, the meta information including applicability information for control and management of the ML model at a RAN node. The RAN node interface component 1135 is capable of, configured to, or operable to support a means for transmitting, to the RAN node, a second message including the meta information for the ML model based on the applicability information included in the meta information.

In some examples, the geographical information component 1155 is capable of, configured to, or operable to support a means for receiving, as part of the applicability information, geographical information indicating where the ML model is applicable, node information where the ML model is applicable, where the node information includes one or more RAN nodes, the RAN node being identified from the one or more RAN nodes based on the node information.

In some examples, the first message including the meta information is received from one of a NEF or a MIMF.

In some examples, the first message including the meta information is received from a DCAF.

In some examples, the first message including the meta information is received from a data collection RAN application function.

In some examples, the ML model is transparent to the RAN node; and transmission of the second message including the meta information for the ML model is based on the ML model being transparent to the RAN node.

Additionally, or alternatively, the communications manager 1120 may support wireless communications at a DCRF in accordance with examples as disclosed herein. The application interface component 1140 is capable of, configured to, or operable to support a means for receiving, from an application service provider, a first message including meta information for a ML model at one or mode devices, the meta information including applicability information for control and management of the ML model at a RAN node. In some examples, the RAN node interface component 1135 is capable of, configured to, or operable to support a means for transmitting, to the RAN node, a second message including the meta information for the ML model based on the applicability information included in the meta information.

In some examples, the meta information request component 1145 is capable of, configured to, or operable to support a means for receiving, from the RAN node, a third message including a request for the meta information, where receiving the first message is in response to the request.

In some examples, the first message is received from the application service provider via an interface configured for communications between a provisioning application function of the application service provider and the DCRF.

In some examples, the second message is transmitted to the RAN node via an interface configured for communications between the DCRF and the RAN node.

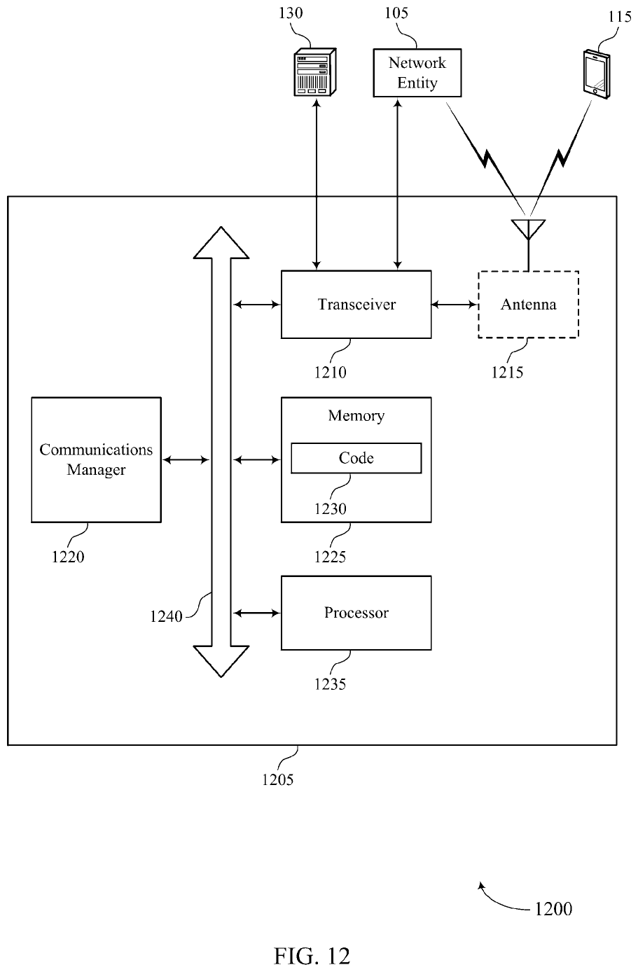

FIG. 12 shows a diagram of a system 1200 including a device 1205 that supports meta information signaling for network devices in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or memory components (for example, the processor 1235, or the memory 1225, or both), may be included in a chip or chip assembly that is installed in the device 1205. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting meta information signaling for network devices). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205. The processor 1235 may be any one or more suitable processors capable of executing scripts or instructions of one or more software programs stored in the device 1205 (such as within the memory 1225). In some implementations, the processor 1235 may be a component of a processing system. A processing system may generally refer to a system or series of machines or components that receives inputs and processes the inputs to produce a set of outputs (which may be passed to other systems or components of, for example, the device 1205). For example, a processing system of the device 1205 may refer to a system including the various other components or subcomponents of the device 1205, such as the processor 1235, or the transceiver 1210, or the communications manager 1220, or other components or combinations of components of the device 1205. The processing system of the device 1205 may interface with other components of the device 1205, and may process information received from other components (such as inputs or signals) or output information to other components. For example, a chip or modem of the device 1205 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1205 may transmit information output from the chip or modem. Additionally, or alternatively, in some implementations, the one or more interfaces may refer to an interface between the processing system of the chip or modem and a receiver, such that the device 1205 may obtain information or signal inputs, and the information may be passed to the processing system. A person having ordinary skill in the art will readily recognize that a first interface also may obtain information or signal inputs, and a second interface also may output information or signal outputs.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communications at a RAN node in accordance with examples as disclosed herein. For example, the communications manager 1220 is capable of, configured to, or operable to support a means for receiving a message including meta information for a ML model at one or more devices, where the RAN node supports communications for the one or more devices, the meta information including applicability information for control and management of the ML model at the RAN node. The communications manager 1220 is capable of, configured to, or operable to support a means for transmitting, based on the meta information, a model management message instructing a device of the one or more devices to perform a model management operation for the ML model.

Additionally, or alternatively, the communications manager 1220 may support wireless communications at an AMF in accordance with examples as disclosed herein. For example, the communications manager 1220 is capable of, configured to, or operable to support a means for receiving a first message including meta information for a ML model at one or more devices, the meta information including applicability information for control and management of the ML model at a RAN node. The communications manager 1220 is capable of, configured to, or operable to support a means for transmitting, to the RAN node, a second message including the meta information for the ML model based on the applicability information included in the meta information.

Additionally, or alternatively, the communications manager 1220 may support wireless communications at a DCRF in accordance with examples as disclosed herein. For example, the communications manager 1220 is capable of, configured to, or operable to support a means for receiving, from an application service provider, a first message including meta information for a ML model at one or mode devices, the meta information including applicability information for control and management of the ML model at a RAN node. The communications manager 1220 is capable of, configured to, or operable to support a means for transmitting, to the RAN node, a second message including the meta information for the ML model based on the applicability information included in the meta information.

By including or configuring the communications manager 1220 in accordance with examples as described herein, the device 1205 may support techniques for enabling a RAN node to receive meta information associated with a ML model at a UE, when the ML model is delivered to the UE transparent to the RAN node, which may result in improved coordination between devices.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, the processor 1235, the memory 1225, the code 1230, or any combination thereof. For example, the code 1230 may include instructions executable by the processor 1235 to cause the device 1205 to perform various aspects of meta information signaling for network devices as described herein, or the processor 1235 and the memory 1225 may be otherwise configured to perform or support such operations.

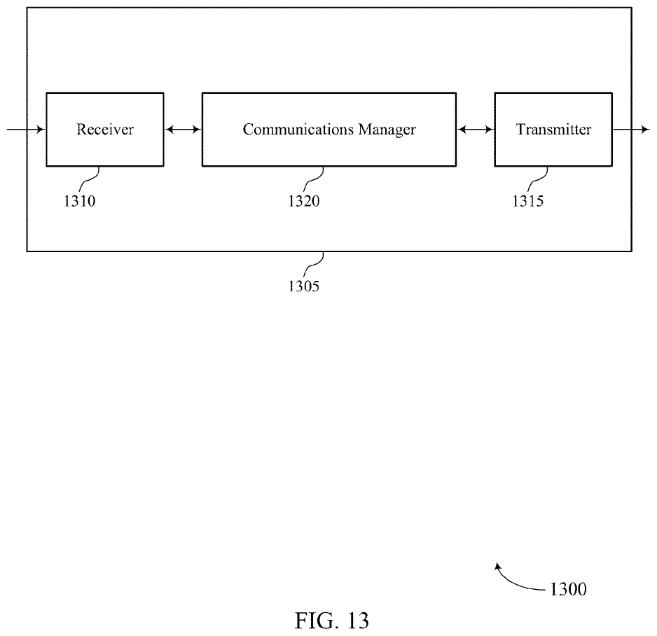

FIG. 13 shows a block diagram 1300 of a device 1305 that supports meta information signaling for network devices in accordance with one or more aspects of the present disclosure. The device 1305 may be an example of aspects of a UE 115 as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for receiving information such as packets, user data, control information, or any combination thereof associated with various information channels (e.g., control channels, data channels, information channels related to meta information signaling for network devices). Information may be passed on to other components of the device 1305. The receiver 1310 may utilize a single antenna or a set of multiple antennas.

The transmitter 1315 may provide a means for transmitting signals generated by other components of the device 1305. For example, the transmitter 1315 may transmit information such as packets, user data, control information, or any combination thereof associated with various information channels (e.g., control channels, data channels, information channels related to meta information signaling for network devices). In some examples, the transmitter 1315 may be co-located with a receiver 1310 in a transceiver module. The transmitter 1315 may utilize a single antenna or a set of multiple antennas.

The communications manager 1320, the receiver 1310, the transmitter 1315, or various combinations thereof or various components thereof may be examples of means for performing various aspects of meta information signaling for network devices as described herein. For example, the communications manager 1320, the receiver 1310, the transmitter 1315, or various combinations or components thereof may support a method for performing one or more of the functions described herein.

In some examples, the communications manager 1320, the receiver 1310, the transmitter 1315, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1320, the receiver 1310, the transmitter 1315, or various combinations or components thereof may be implemented in code (e.g., as communications management software or firmware) executed by a processor. If implemented in code executed by a processor, the functions of the communications manager 1320, the receiver 1310, the transmitter 1315, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1320 may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications at a UE in accordance with examples as disclosed herein. For example, the communications manager 1320 is capable of, configured to, or operable to support a means for receiving, from an application function, a message including meta information for a ML model supported by the UE. The communications manager 1320 is capable of, configured to, or operable to support a means for transmitting, to a RAN node, a control message to update the meta information for the ML model at the RAN node, the control message including the meta information for the ML model supported by the UE, where the meta information includes applicability information for control and management of the ML model.

By including or configuring the communications manager 1320 in accordance with examples as described herein, the device 1305 (e.g., a processor controlling or otherwise coupled with the receiver 1310, the transmitter 1315, the communications manager 1320, or a combination thereof) may support techniques for enabling a RAN node to receive meta information associated with a ML model at a UE, when the ML model is delivered to the UE transparent to the RAN node, which may result in improved coordination between devices.

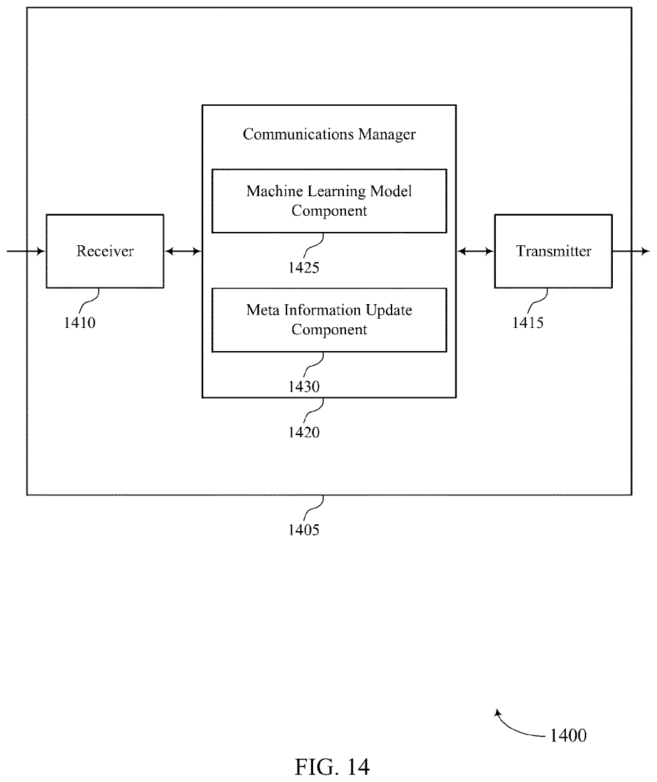

FIG. 14 shows a block diagram 1400 of a device 1405 that supports meta information signaling for network devices in accordance with one or more aspects of the present disclosure. The device 1405 may be an example of aspects of a device 1305 or a UE 115 as described herein. The device 1405 may include a receiver 1410, a transmitter 1415, and a communications manager 1420. The device 1405 may also include a processor. Each of these components may be in communication with one another (e.g., via one or more buses).

The receiver 1410 may provide a means for receiving information such as packets, user data, control information, or any combination thereof associated with various information channels (e.g., control channels, data channels, information channels related to meta information signaling for network devices). Information may be passed on to other components of the device 1405. The receiver 1410 may utilize a single antenna or a set of multiple antennas.

The transmitter 1415 may provide a means for transmitting signals generated by other components of the device 1405. For example, the transmitter 1415 may transmit information such as packets, user data, control information, or any combination thereof associated with various information channels (e.g., control channels, data channels, information channels related to meta information signaling for network devices). In some examples, the transmitter 1415 may be co-located with a receiver 1410 in a transceiver module. The transmitter 1415 may utilize a single antenna or a set of multiple antennas.

The device 1405, or various components thereof, may be an example of means for performing various aspects of meta information signaling for network devices as described herein. For example, the communications manager 1420 may include a ML model component 1425 a meta information update component 1430, or any combination thereof. The communications manager 1420 may be an example of aspects of a communications manager 1320 as described herein. In some examples, the communications manager 1420, or various components thereof, may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The communications manager 1420 may support wireless communications at a UE in accordance with examples as disclosed herein. The ML model component 1425 is capable of, configured to, or operable to support a means for receiving, from an application function, a message including meta information for a ML model supported by the UE. The meta information update component 1430 is capable of, configured to, or operable to support a means for transmitting, to a RAN node, a control message to update the meta information for the ML model at the RAN node, the control message including the meta information for the ML model supported by the UE, where the meta information includes applicability information for control and management of the ML model.

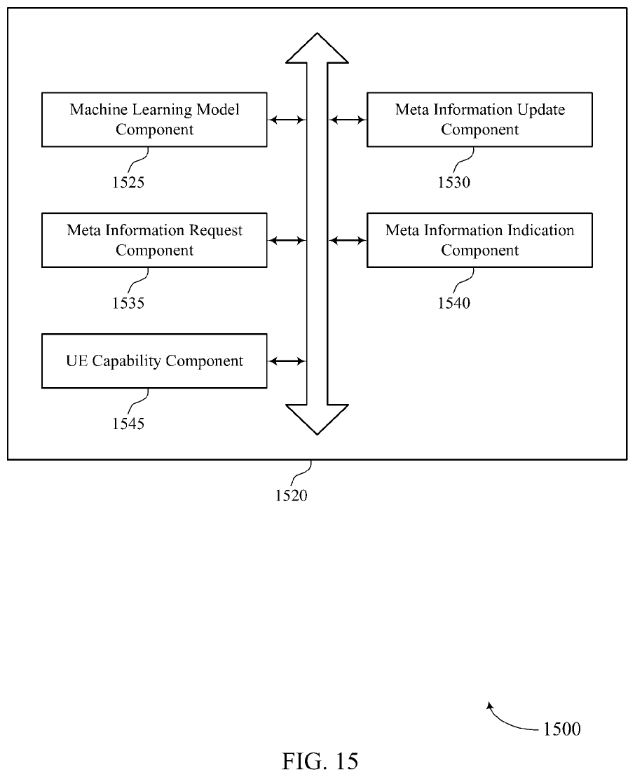

FIG. 15 shows a block diagram 1500 of a communications manager 1520 that supports meta information signaling for network devices in accordance with one or more aspects of the present disclosure. The communications manager 1520 may be an example of aspects of a communications manager 1320, a communications manager 1420, or both, as described herein. The communications manager 1520, or various components thereof, may be an example of means for performing various aspects of meta information signaling for network devices as described herein. For example, the communications manager 1520 may include a ML model component 1525, a meta information update component 1530, a meta information request component 1535, a meta information indication component 1540, a UE capability component 1545, or any combination thereof. Each of these components may communicate, directly or indirectly, with one another (e.g., via one or more buses).

The communications manager 1520 may support wireless communications at a UE in accordance with examples as disclosed herein. The ML model component 1525 is capable of, configured to, or operable to support a means for receiving, from an application function, a message including meta information for a ML model supported by the UE. The meta information update component 1530 is capable of, configured to, or operable to support a means for transmitting, to a RAN node, a control message to update the meta information for the ML model at the RAN node, the control message including the meta information for the ML model supported by the UE, where the meta information includes applicability information for control and management of the ML model.

In some examples, the meta information request component 1535 is capable of, configured to, or operable to support a means for receiving, from the RAN node, a request for transmission of the meta information associated with the ML model, the message including the applicability information, where the control message is transmitted in response to the request.

In some examples, the meta information indication component 1540 is capable of, configured to, or operable to support a means for transmitting, to the RAN node, an indication that the UE has an update for the meta information, where the message is received in response to the indication.

In some examples, the UE capability component 1545 is capable of, configured to, or operable to support a means for transmitting, to the RAN node, a capability message indicating that the UE supports the ML model, the capability message including the applicability information for the control and the management of the ML model.

In some examples, the message including the meta information for the ML model is based on the ML model being transparent to the RAN node.

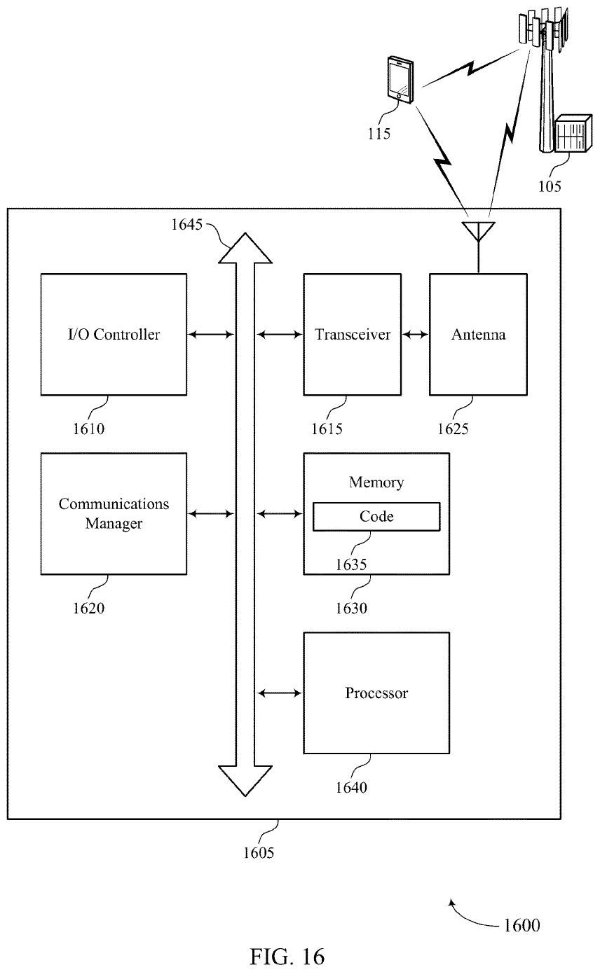

FIG. 16 shows a diagram of a system 1600 including a device 1605 that supports meta information signaling for network devices in accordance with one or more aspects of the present disclosure. The device 1605 may be an example of or include the components of a device 1305, a device 1405, or a UE 115 as described herein. The device 1605 may communicate (e.g., wirelessly) with one or more network entities 105, one or more UEs 115, or any combination thereof. The device 1605 may include components for bi-directional voice and data communications including components for transmitting and receiving communications, such as a communications manager 1620, an input/output (I/O) controller 1610, a transceiver 1615, an antenna 1625, a memory 1630, code 1635, and a processor 1640. These components may be in electronic communication or otherwise coupled (e.g., operatively, communicatively, functionally, electronically, electrically) via one or more buses (e.g., a bus 1645).

The I/O controller 1610 may manage input and output signals for the device 1605. The I/O controller 1610 may also manage peripherals not integrated into the device 1605. In some cases, the I/O controller 1610 may represent a physical connection or port to an external peripheral. In some cases, the I/O controller 1610 may utilize an operating system such as iOS®, ANDROID®, MS-DOS®, MS-WINDOWS®, OS/2®, UNIX®, LINUX®, or another known operating system. Additionally, or alternatively, the I/O controller 1610 may represent or interact with a modem, a keyboard, a mouse, a touchscreen, or a similar device. In some cases, the I/O controller 1610 may be implemented as part of a processor, such as the processor 1640. In some cases, a user may interact with the device 1605 via the I/O controller 1610 or via hardware components controlled by the I/O controller 1610.

In some cases, the device 1605 may include a single antenna 1625. However, in some other cases, the device 1605 may have more than one antenna 1625, which may be capable of concurrently transmitting or receiving multiple wireless transmissions.

The transceiver 1615 may communicate bi-directionally, via the one or more antennas 1625, wired, or wireless links as described herein. For example, the transceiver 1615 may represent a wireless transceiver and may communicate bi-directionally with another wireless transceiver. The transceiver 1615 may also include a modem to modulate the packets, to provide the modulated packets to one or more antennas 1625 for transmission, and to demodulate packets received from the one or more antennas 1625. The transceiver 1615, or the transceiver 1615 and one or more antennas 1625, may be an example of a transmitter 1315, a transmitter 1415, a receiver 1310, a receiver 1410, or any combination thereof or component thereof, as described herein.

The memory 1630 may include random access memory (RAM) and read-only memory (ROM). The memory 1630 may store computer-readable, computer-executable code 1635 including instructions that, when executed by the processor 1640, cause the device 1605 to perform various functions described herein. The code 1635 may be stored in a non-transitory computer-readable medium such as system memory or another type of memory. In some cases, the code 1635 may not be directly executable by the processor 1640 but may cause a computer (e.g., when compiled and executed) to perform functions described herein. In some cases, the memory 1630 may contain, among other things, a basic I/O system (BIOS) which may control basic hardware or software operation such as the interaction with peripheral components or devices.

The processor 1640 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1640 may be configured to operate a memory array using a memory controller. In some other cases, a memory controller may be integrated into the processor 1640. The processor 1640 may be configured to execute computer-readable instructions stored in a memory (e.g., the memory 1630) to cause the device 1605 to perform various functions (e.g., functions or tasks supporting meta information signaling for network devices). For example, the device 1605 or a component of the device 1605 may include a processor 1640 and memory 1630 coupled with or to the processor 1640, the processor 1640 and memory 1630 configured to perform various functions described herein.

The communications manager 1620 may support wireless communications at a UE in accordance with examples as disclosed herein. For example, the communications manager 1620 is capable of, configured to, or operable to support a means for receiving, from an application function, a message including meta information for a ML model supported by the UE. The communications manager 1620 is capable of, configured to, or operable to support a means for transmitting, to a RAN node, a control message to update the meta information for the ML model at the RAN node, the control message including the meta information for the ML model supported by the UE, where the meta information includes applicability information for control and management of the ML model.

By including or configuring the communications manager 1620 in accordance with examples as described herein, the device 1605 may support techniques for enabling a RAN node to receive meta information associated with a ML model at a UE, when the ML model is delivered to the UE transparent to the RAN node, which may result in improved coordination between devices.

In some examples, the communications manager 1620 may be configured to perform various operations (e.g., receiving, monitoring, transmitting) using or otherwise in cooperation with the transceiver 1615, the one or more antennas 1625, or any combination thereof. Although the communications manager 1620 is illustrated as a separate component, in some examples, one or more functions described with reference to the communications manager 1620 may be supported by or performed by the processor 1640, the memory 1630, the code 1635, or any combination thereof. For example, the code 1635 may include instructions executable by the processor 1640 to cause the device 1605 to perform various aspects of meta information signaling for network devices as described herein, or the processor 1640 and the memory 1630 may be otherwise configured to perform or support such operations.

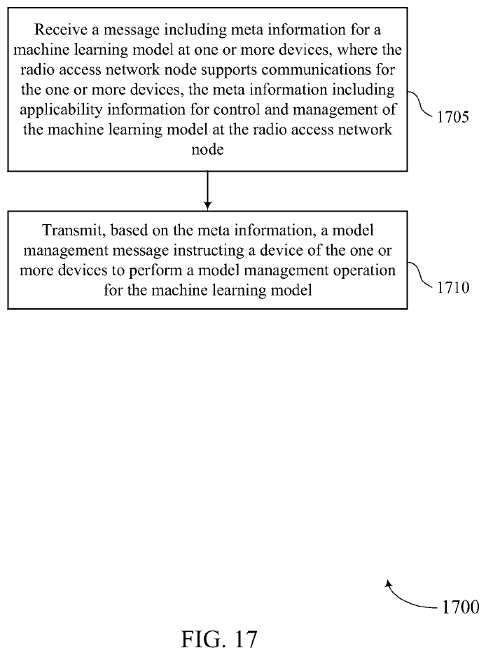

FIG. 17 shows a flowchart illustrating a method 1700 that supports meta information signaling for network devices in accordance with aspects of the present disclosure. The operations of the method 1700 may be implemented by a network entity or its components as described herein. For example, the operations of the method 1700 may be performed by a network entity as described with reference to FIGS. 1 through 12. In some examples, a network entity may execute a set of instructions to control the functional elements of the wireless network entity to perform the described functions. Additionally, or alternatively, the wireless network entity may perform aspects of the described functions using special-purpose hardware.

At 1705, the method may include receiving a message including meta information for a ML model at one or more devices, where the RAN node supports communications for the one or more devices, the meta information including applicability information for control and management of the ML model at the RAN node. The operations of 1705 may be performed in accordance with examples as disclosed herein. In some examples, aspects of the operations of 1705 may be performed by a meta information component 1125 as described with reference to FIG. 11.

At 1710, the method may include transmitting, based on the meta information, a model management message instructing a device of the one or more devices to perform a model management operation for the ML model. The operations of 1710 may be performed in accordance with examples as disclosed herein. In some examples, aspects of the operations of 1710 may be performed by a model management component 1130 as described with reference to FIG. 11.

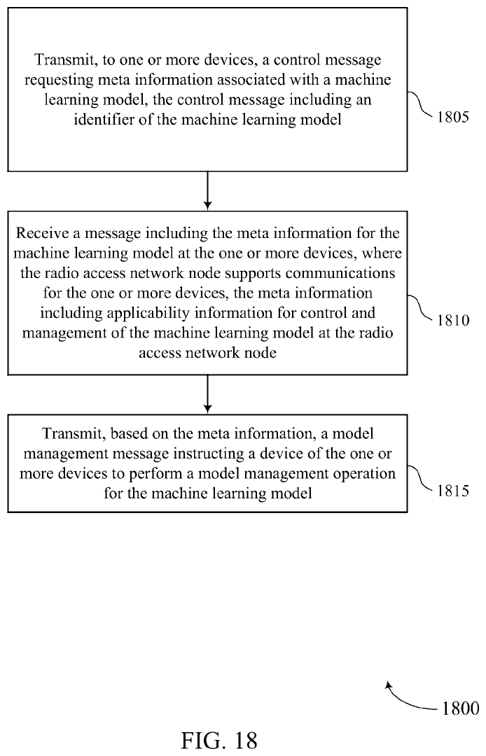

FIG. 18 shows a flowchart illustrating a method 1800 that supports meta information signaling for network devices in accordance with aspects of the present disclosure. The operations of the method 1800 may be implemented by a network entity or its components as described herein. For example, the operations of the method 1800 may be performed by a network entity as described with reference to FIGS. 1 through 12. In some examples, a network entity may execute a set of instructions to control the functional elements of the wireless network entity to perform the described functions. Additionally, or alternatively, the wireless network entity may perform aspects of the described functions using special-purpose hardware.

At 1805, the method may include transmitting, to one or more devices, a control message requesting meta information associated with a ML model, the control message including an identifier of the ML model. The operations of 1805 may be performed in accordance with examples as disclosed herein. In some examples, aspects of the operations of 1805 may be performed by a meta information request component 1145 as described with reference to FIG. 11.

At 1810, the method may include receiving a message including the meta information for the ML model at the one or more devices, where the RAN node supports communications for the one or more devices, the meta information including applicability information for control and management of the ML model at the RAN node. The operations of 1810 may be performed in accordance with examples as disclosed herein. In some examples, aspects of the operations of 1810 may be performed by a meta information component 1125 as described with reference to FIG. 11.

At 1815, the method may include transmitting, based on the meta information, a model management message instructing a device of the one or more devices to perform a model management operation for the ML model. The operations of 1815 may be performed in accordance with examples as disclosed herein. In some examples, aspects of the operations of 1815 may be performed by a model management component 1130 as described with reference to FIG. 11.

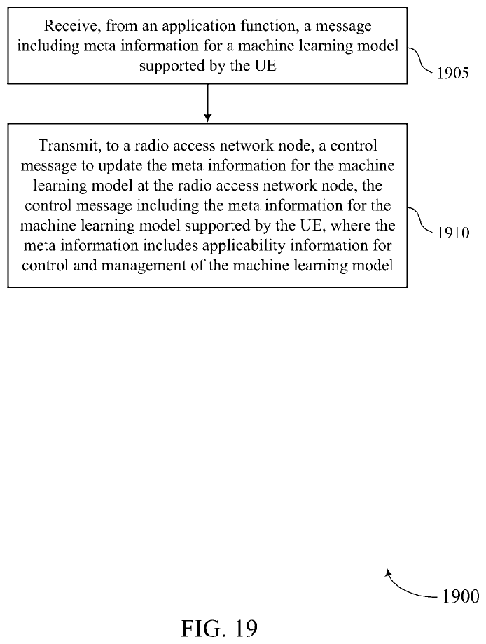

FIG. 19 shows a flowchart illustrating a method 1900 that supports meta information signaling for network devices in accordance with aspects of the present disclosure. The operations of the method 1900 may be implemented by a UE or its components as described herein. For example, the operations of the method 1900 may be performed by a UE 115 as described with reference to FIGS. 1 through 8 and 13 through 16. In some examples, a UE may execute a set of instructions to control the functional elements of the wireless UE to perform the described functions. Additionally, or alternatively, the wireless UE may perform aspects of the described functions using special-purpose hardware.

At 1905, the method may include receiving, from an application function, a message including meta information for a ML model supported by the UE. The operations of 1905 may be performed in accordance with examples as disclosed herein. In some examples, aspects of the operations of 1905 may be performed by a ML model component 1525 as described with reference to FIG. 15.

At 1910, the method may include transmitting, to a RAN node, a control message to update the meta information for the ML model at the RAN node, the control message including the meta information for the ML model supported by the UE, where the meta information includes applicability information for control and management of the ML model. The operations of 1910 may be performed in accordance with examples as disclosed herein. In some examples, aspects of the operations of 1910 may be performed by a meta information update component 1530 as described with reference to FIG. 15.

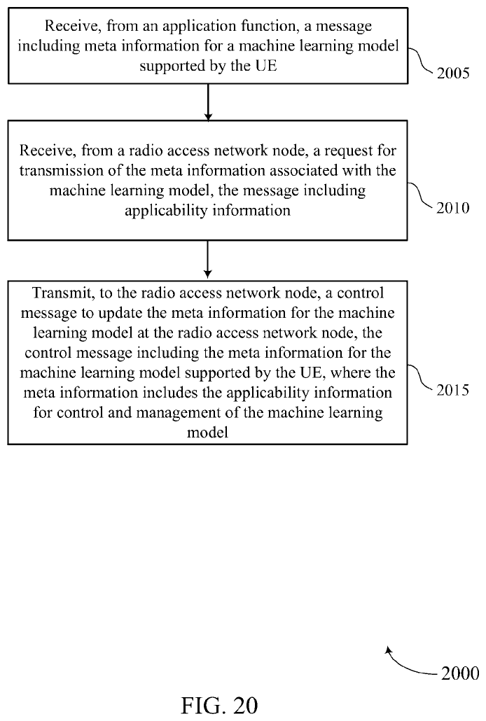

FIG. 20 shows a flowchart illustrating a method 2000 that supports meta information signaling for network devices in accordance with aspects of the present disclosure. The operations of the method 2000 may be implemented by a UE or its components as described herein. For example, the operations of the method 2000 may be performed by a UE 115 as described with reference to FIGS. 1 through 8 and 13 through 16. In some examples, a UE may execute a set of instructions to control the functional elements of the wireless UE to perform the described functions. Additionally, or alternatively, the wireless UE may perform aspects of the described functions using special-purpose hardware.

At 2005, the method may include receiving, from an application function, a message including meta information for a ML model supported by the UE. The operations of 2005 may be performed in accordance with examples as disclosed herein. In some examples, aspects of the operations of 2005 may be performed by a ML model component 1525 as described with reference to FIG. 15.

At 2010, the method may include receiving, from a RAN node, a request for transmission of the meta information associated with the ML model, the message including the applicability information. The operations of 2010 may be performed in accordance with examples as disclosed herein. In some examples, aspects of the operations of 2010 may be performed by a meta information request component 1535 as described with reference to FIG. 15.

At 2015, the method may include transmitting, to the RAN node, a control message to update the meta information for the ML model at the RAN node, the control message including the meta information for the ML model supported by the UE, where the meta information includes applicability information for control and management of the ML model. The operations of 2015 may be performed in accordance with examples as disclosed herein. In some examples, aspects of the operations of 2015 may be performed by a meta information update component 1530 as described with reference to FIG. 15.

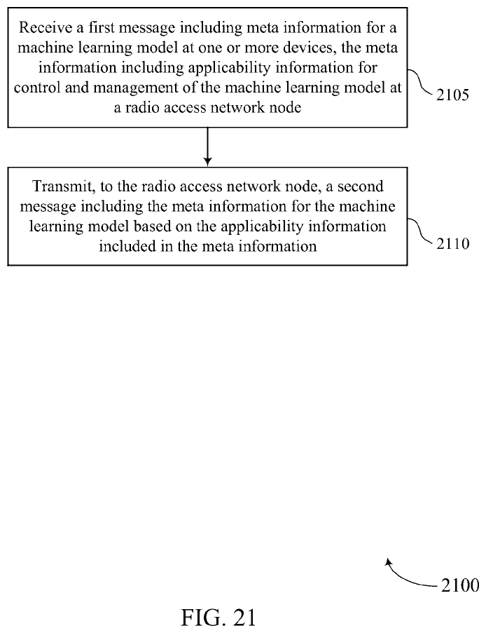

FIG. 21 shows a flowchart illustrating a method 2100 that supports meta information signaling for network devices in accordance with aspects of the present disclosure. The operations of the method 2100 may be implemented by a network entity or its components as described herein. For example, the operations of the method 2100 may be performed by a network entity as described with reference to FIGS. 1 through 12. In some examples, a network entity may execute a set of instructions to control the functional elements of the wireless network entity to perform the described functions. Additionally, or alternatively, the wireless network entity may perform aspects of the described functions using special-purpose hardware.

At 2105, the method may include receiving a first message including meta information for a ML model at one or more devices, the meta information including applicability information for control and management of the ML model at a RAN node. The operations of 2105 may be performed in accordance with examples as disclosed herein. In some examples, aspects of the operations of 2105 may be performed by a meta information component 1125 as described with reference to FIG. 11.

At 2110, the method may include transmitting, to the RAN node, a second message including the meta information for the ML model based on the applicability information included in the meta information. The operations of 2110 may be performed in accordance with examples as disclosed herein. In some examples, aspects of the operations of 2110 may be performed by a RAN node interface component 1135 as described with reference to FIG. 11.

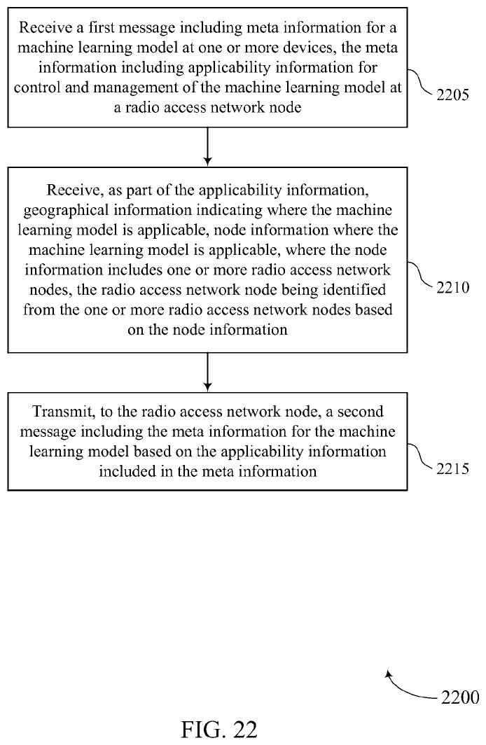

FIG. 22 shows a flowchart illustrating a method 2200 that supports meta information signaling for network devices in accordance with aspects of the present disclosure. The operations of the method 2200 may be implemented by a network entity or its components as described herein. For example, the operations of the method 2200 may be performed by a network entity as described with reference to FIGS. 1 through 12. In some examples, a network entity may execute a set of instructions to control the functional elements of the wireless network entity to perform the described functions. Additionally, or alternatively, the wireless network entity may perform aspects of the described functions using special-purpose hardware.

At 2205, the method may include receiving a first message including meta information for a ML model at one or more devices, the meta information including applicability information for control and management of the ML model at a RAN node. The operations of 2205 may be performed in accordance with examples as disclosed herein. In some examples, aspects of the operations of 2205 may be performed by a meta information component 1125 as described with reference to FIG. 11.

At 2210, the method may include receiving, as part of the applicability information, geographical information indicating where the ML model is applicable, node information where the ML model is applicable, where the node information includes one or more RAN nodes, the RAN node being identified from the one or more RAN nodes based on the node information. The operations of 2210 may be performed in accordance with examples as disclosed herein. In some examples, aspects of the operations of 2210 may be performed by a geographical information component 1155 as described with reference to FIG. 11.

At 2215, the method may include transmitting, to the RAN node, a second message including the meta information for the ML model based on the applicability information included in the meta information. The operations of 2215 may be performed in accordance with examples as disclosed herein. In some examples, aspects of the operations of 2215 may be performed by a RAN node interface component 1135 as described with reference to FIG. 11.

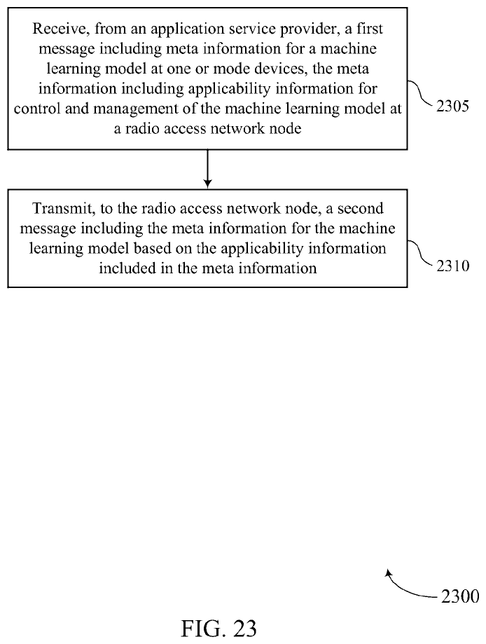

FIG. 23 shows a flowchart illustrating a method 2300 that supports meta information signaling for network devices in accordance with aspects of the present disclosure. The operations of the method 2300 may be implemented by a network entity or its components as described herein. For example, the operations of the method 2300 may be performed by a network entity as described with reference to FIGS. 1 through 12. In some examples, a network entity may execute a set of instructions to control the functional elements of the wireless network entity to perform the described functions. Additionally, or alternatively, the wireless network entity may perform aspects of the described functions using special-purpose hardware.

At 2305, the method may include receiving, from an application service provider, a first message including meta information for a ML model at one or mode devices, the meta information including applicability information for control and management of the ML model at a RAN node. The operations of 2305 may be performed in accordance with examples as disclosed herein. In some examples, aspects of the operations of 2305 may be performed by an application interface component 1140 as described with reference to FIG. 11.

At 2310, the method may include transmitting, to the RAN node, a second message including the meta information for the ML model based on the applicability information included in the meta information. The operations of 2310 may be performed in accordance with examples as disclosed herein. In some examples, aspects of the operations of 2310 may be performed by a RAN node interface component 1135 as described with reference to FIG. 11.

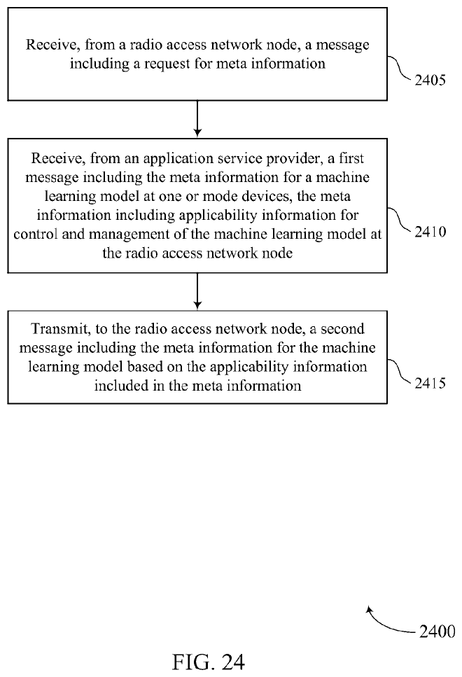

FIG. 24 shows a flowchart illustrating a method 2400 that supports meta information signaling for network devices in accordance with aspects of the present disclosure. The operations of the method 2400 may be implemented by a network entity or its components as described herein. For example, the operations of the method 2400 may be performed by a network entity as described with reference to FIGS. 1 through 12. In some examples, a network entity may execute a set of instructions to control the functional elements of the wireless network entity to perform the described functions. Additionally, or alternatively, the wireless network entity may perform aspects of the described functions using special-purpose hardware.

At 2405, the method may include receiving, from a RAN node, a message including a request for meta information. The operations of 2405 may be performed in accordance with examples as disclosed herein. In some examples, aspects of the operations of 2405 may be performed by a meta information request component 1145 as described with reference to FIG. 11.

At 2410, the method may include receiving, from an application service provider, a first message including the meta information for a ML model at one or mode devices, the meta information including applicability information for control and management of the ML model at the RAN node. The operations of 2410 may be performed in accordance with examples as disclosed herein. In some examples, aspects of the operations of 2410 may be performed by an application interface component 1140 as described with reference to FIG. 11.

At 2415, the method may include transmitting, to the RAN node, a second message including the meta information for the ML model based on the applicability information included in the meta information. The operations of 2415 may be performed in accordance with examples as disclosed herein. In some examples, aspects of the operations of 2415 may be performed by a RAN node interface component 1135 as described with reference to FIG. 11.

The following provides an overview of aspects of the present disclosure:

Aspect 1: A method for wireless communications at a RAN node, comprising: receiving a message comprising meta information for a ML model at one or more devices, wherein the RAN node supports communications for the one or more devices, the meta information including applicability information for control and management of the ML model at the RAN node; and transmitting, based at least in part on the meta information, a model management message instructing a device of the one or more devices to perform a model management operation for the ML model.

Aspect 2: The method of aspect 1, further comprising: transmitting, to the one or more devices, a control message requesting the meta information associated with the ML model, the control message comprising an identifier of the ML model, wherein the message comprising the meta information is received from the one or more devices in response to the control message.

Aspect 3: The method of aspect 2, further comprising: receiving, from the one or more devices, a capability message indicating that the one or more devices support the ML model, the capability message comprising the applicability information, wherein transmission of the control message is in response to the capability message.

Aspect 4: The method of any of aspects 2 through 3, further comprising: receiving, from the one or more devices, an indication that the one or more devices have an update for the meta information, wherein transmission of the control message is in response to the indication.

Aspect 5: The method of aspect 1, wherein the message comprises a meta information update request message and is received from a logical function in communication with the RAN node, the method further comprising: transmitting, to the logical function, a meta information update response message indicating that the meta information associated with the ML model is updated at the RAN node based at least in part on reception of the message, the meta information update response message comprising the applicability information.

Aspect 6: The method of aspect 5, wherein the logical function comprises at least one of an OAM function or a SMO function.

Aspect 7: The method of any of aspects 1 through 6, wherein receiving the message comprises: receiving the message comprising the meta information for the ML model based at least in part on the ML model being transparent to the RAN node.

Aspect 8: The method of any of aspects 1 through 7, wherein receiving the message comprises: receiving the message comprising the ML model in addition to the meta information for the ML model.

Aspect 9: The method of aspect 8, further comprising: storing the meta information at the RAN node; and transmitting, as part of the model management message and to the one or more devices, the meta information for the ML model and the ML model based at least in part on storing the meta information at the RAN node, wherein the control and the management of the ML model at the one or more devices is in accordance with the meta information.

Aspect 10: The method of aspect 1, wherein receiving the message comprises: receiving the message comprising the meta information from an AMF.

Aspect 11: The method of aspect 1, wherein receiving the message comprises: receiving the message comprising the meta information via a direct interface from a DCAF.

Aspect 12: The method of aspect 1, wherein receiving the message comprises: receiving the message comprising the meta information via an interface from a DCRF.

Aspect 13: The method of aspect 1, wherein receiving the message comprises: receiving the message comprising the meta information from a UE, wherein the message comprises a UE assistance information message.

Aspect 14: The method of any of aspects 1 through 13, wherein the meta information is identified at the RAN node based at least in part on the applicability information for the ML model, the applicability information comprising an identifier of the ML model, an identifier of the meta information, a version of the meta information, a tag associated with the meta information, or a combination thereof.

Aspect 15: A method for wireless communications at a UE, comprising: receiving, from an application function, a message comprising meta information for a ML model supported by the UE; and transmitting, to a RAN node, a control message to update the meta information for the ML model at the RAN node, the control message comprising the meta information for the ML model supported by the UE, wherein the meta information includes applicability information for control and management of the ML model.

Aspect 16: The method of aspect 15, further comprising: receiving, from the RAN node, a request for transmission of the meta information associated with the ML model, the message comprising the applicability information, wherein the control message is transmitted in response to the request.

Aspect 17: The method of aspect 16, further comprising: transmitting, to the RAN node, an indication that the UE has an update for the meta information, wherein the message is received in response to the indication.

Aspect 18: The method of any of aspects 16 through 17, further comprising: transmitting, to the RAN node, a capability message indicating that the UE supports the ML model, the capability message comprising the applicability information for the control and the management of the ML model.

Aspect 19: The method of any of aspects 15 through 18, wherein the message comprising the meta information for the ML model is based at least in part on the ML model being transparent to the RAN node.

Aspect 20: A method for wireless communications at an AMF, comprising: receiving a first message comprising meta information for a ML model at one or more devices, the meta information including applicability information for control and management of the ML model at a RAN node; and transmitting, to the RAN node, a second message comprising the meta information for the ML model based at least in part on the applicability information included in the meta information.

Aspect 21: The method of aspect 20, further comprising: receiving, as part of the applicability information, geographical information indicating where the ML model is applicable, node information where the ML model is applicable, wherein the node information comprises one or more RAN nodes, the RAN node being identified from the one or more RAN nodes based at least in part on the node information.

Aspect 22: The method of any of aspects 20 through 21, wherein the first message comprising the meta information is received from one of a NEF or a MIMF.

Aspect 23: The method of any of aspects 20 through 21, wherein the first message comprising the meta information is received from a DCAF.

Aspect 24: The method of any of aspects 20 through 21, wherein the first message comprising the meta information is received from a DCRF.

Aspect 25: The method of any of aspects 20 through 24, wherein the ML model is transparent to the RAN node; and transmission of the second message comprising the meta information for the ML model is based at least in part on the ML model being transparent to the RAN node.

Aspect 26: A method for wireless communications at a DCRF, comprising: receiving, from an application service provider, a first message comprising meta information for a ML model at one or mode devices, the meta information including applicability information for control and management of the ML model at a RAN node; and transmitting, to the RAN node, a second message comprising the meta information for the ML model based at least in part on the applicability information included in the meta information.

Aspect 27: The method of aspect 26, further comprising: receiving, from the RAN node, a third message comprising a request for the meta information, wherein receiving the first message is in response to the request.

Aspect 28: The method of any of aspects 26 through 27, wherein the first message is received from the application service provider via an interface configured for communications between a provisioning application function of the application service provider and the DCRF.

Aspect 29: The method of any of aspects 26 through 28, wherein the second message is transmitted to the RAN node via an interface configured for communications between the DCRF and the RAN node.

Aspect 30: An apparatus for wireless communications at a RAN node, comprising a processor; memory coupled with the processor; and instructions stored in the memory and executable by the processor to cause the apparatus to perform a method of any of aspects 1 through 14.

Aspect 31: An apparatus for wireless communications at a RAN node, comprising at least one means for performing a method of any of aspects 1 through 14.

Aspect 32: A non-transitory computer-readable medium storing code for wireless communications at a RAN node, the code comprising instructions executable by a processor to perform a method of any of aspects 1 through 14.

Aspect 33: An apparatus for wireless communications at a UE, comprising a processor; memory coupled with the processor; and instructions stored in the memory and executable by the processor to cause the apparatus to perform a method of any of aspects 15 through 19.

Aspect 34: An apparatus for wireless communications at a UE, comprising at least one means for performing a method of any of aspects 15 through 19.

Aspect 35: A non-transitory computer-readable medium storing code for wireless communications at a UE, the code comprising instructions executable by a processor to perform a method of any of aspects 15 through 19.

Aspect 36: An apparatus for wireless communications at an AMF, comprising a processor; memory coupled with the processor; and instructions stored in the memory and executable by the processor to cause the apparatus to perform a method of any of aspects 20 through 25.

Aspect 37: An apparatus for wireless communications at an AMF, comprising at least one means for performing a method of any of aspects 20 through 25.

Aspect 38: A non-transitory computer-readable medium storing code for wireless communications at an AMF, the code comprising instructions executable by a processor to perform a method of any of aspects 20 through 25.

Aspect 39: An apparatus for wireless communications at a DCRF, comprising a processor; memory coupled with the processor; and instructions stored in the memory and executable by the processor to cause the apparatus to perform a method of any of aspects 26 through 29.

Aspect 40: An apparatus for wireless communications at a DCRF, comprising at least one means for performing a method of any of aspects 26 through 29.

Aspect 41: A non-transitory computer-readable medium storing code for wireless communications at a DCRF, the code comprising instructions executable by a processor to perform a method of any of aspects 26 through 29.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus of an ambient wireless device for wireless communications, comprising:
a processor; and
memory coupled with the processor, the processor configured to:
receive a control message that indicates a resource pool allocation for the ambient wireless device, the resource pool allocation comprising a plurality of resources for backscatter communications between the ambient wireless device and a user equipment (UE);
receive, from the UE, a sidelink data message via a first resource of the plurality of resources based at least in part on the resource pool allocation;
receive, via a second resource of the plurality of resources, a continuous waveform for activation of the ambient wireless device to provide feedback for the sidelink data message;
modulate the continuous waveform with feedback information for the sidelink data message; and
send, via a third resource of the plurality of resources, a backscattered signal of the continuous waveform modulated with the feedback information for the sidelink data message.

2. The apparatus of claim 1, wherein the continuous waveform is received from the UE, the processor is further configured to:
receive, from the UE, a feedback resource message indicating that the third resource is allocated for the ambient wireless device to provide feedback for the sidelink data message, the backscattered signal sent via the third resource based at least in part on the feedback resource message.

3. The apparatus of claim 1, wherein, to send the backscattered signal, the processor is configured to:
send, via the third resource of the plurality of resources, the backscattered signal, the third resource selected by the UE.

4. The apparatus of claim 3, wherein the processor is further configured to:
receive an indication of a set of resources for feedback for the sidelink data message based at least in part on a mapping of the first resource to the set of resources, the third resource selected from the set of resources.

5. The apparatus of claim 1, wherein the processor is further configured to:
receive, via the control message, an indication of a frequency range for the plurality of resources for backscatter communications.

6. The apparatus of claim 1, wherein the processor is further configured to:
receive, via the control message, an indication of a guard band between the plurality of resources for backscatter communications and a second plurality of resources for sidelink communications.

7. The apparatus of claim 1, wherein the processor is further configured to:
receive a second continuous waveform for a discovery procedure between the ambient wireless device and the UE;
modulate the second continuous waveform with an acknowledgment of the discovery procedure; and
send, as part of the discovery procedure, a second backscattered signal of the second continuous waveform modulated with the acknowledgment of the discovery procedure.

8. An apparatus of a user equipment (UE) for wireless communications, comprising:
a processor; and
memory coupled with the processor, the processor configured to:
receive a control message that indicates a resource pool allocation for the UE, the resource pool allocation comprising a plurality of resources for backscatter communications between the UE and an ambient wireless device;
transmit, to the ambient wireless device, a sidelink data message via a first resource of the plurality of resources based at least in part on the resource pool allocation;
transmit, via a second resource of the plurality of resources, a continuous waveform for activation of the ambient wireless device to provide feedback for the sidelink data message; and
receive, via a third resource of the plurality of resources, a backscattered signal of the continuous waveform modulated with feedback information for the sidelink data message.

9. The apparatus of claim 8, wherein the processor is further configured to:
transmit, to the ambient wireless device, a feedback resource message indicating that the third resource is allocated for feedback for the sidelink data message, the backscattered signal received via the third resource based at least in part on the feedback resource message.

10. The apparatus of claim 8, wherein the processor is further configured to:
receive, via the control message, an indication of a frequency range for the plurality of resources for backscatter communications.

11. The apparatus of claim 8, wherein the processor is further configured to:
receive, via the control message, an indication of a guard band between the plurality of resources for backscatter communications and a second plurality of resources for sidelink communications.

12. The apparatus of claim 8, wherein the processor is further configured to:
transmit, to the ambient wireless device, a second continuous waveform for a discovery procedure between the ambient wireless device and the UE; and
receive, from the ambient wireless device as part of the discovery procedure, a second backscattered signal of the second continuous waveform modulated with an acknowledgment of the discovery procedure.

13. An apparatus of an ambient wireless device for wireless communications, comprising:
a processor; and
memory coupled with the processor, the processor configured to:
receive a control message that indicates a resource pool allocation for the ambient wireless device, the resource pool allocation comprising a plurality of resources for backscatter communications between the ambient wireless device and a user equipment (UE);
receive an indication of one or more resources of the plurality of resources for the ambient wireless device to use to backscatter a sidelink data message;
receive, via a first resource of the one or more resources, a continuous waveform for sidelink communications from the ambient wireless device;
modulate the continuous waveform with the sidelink data message; and
send, via a second resource of the one or more resources, a backscattered signal of the continuous waveform modulated with the sidelink data message.

14. The apparatus of claim 13, wherein the processor is further configured to:
receive, from the UE, a feedback message that comprises feedback information associated with the sidelink data message based at least in part on the backscattered signal of the continuous waveform modulated with the sidelink data message.

15. The apparatus of claim 13, wherein the processor is further configured to:
receive a second continuous waveform for activation of the ambient wireless device to perform backscatter communications;
modulate the second continuous waveform with a backscatter request message associated with the sidelink data message, the backscatter request message comprising a request for one or more resources for the ambient wireless device to send the sidelink data message; and
send, via a third resource of the plurality of resources, a second backscattered signal of the second continuous waveform modulated with the backscatter request message.

16. The apparatus of claim 15, wherein the processor is further configured to:
receive the second continuous waveform from the UE or a second UE different from the UE.

17. The apparatus of claim 15, wherein the third resource of the plurality of resources is allocated for the ambient wireless device to send one or more backscatter request messages, the third resource is common to a set of ambient wireless devices or is a resource of a communication link associated with the ambient wireless device.

18. The apparatus of claim 13, wherein the processor is further configured to:
send an indication that the ambient wireless device selected the second resource of the one or more resources to backscatter the sidelink data message; and
receive an acknowledgment message for the indication of the second resource.

19. The apparatus of claim 13, wherein, to receive the indication of the one or more resources, the processor is configured to:
receive the indication of the one or more resources of the plurality of resources from the UE or a second UE different from the UE.

20. The apparatus of claim 13, wherein the processor is further configured to:
receive a second continuous waveform for a discovery procedure between the ambient wireless device and the UE;
modulate the second continuous waveform with capability information of the ambient wireless device; and
send, as part of the discovery procedure, a second backscattered signal of the second continuous waveform modulated with the capability information of the ambient wireless device.

21-30. (canceled)
